(19) United States
(12) Patent Application Publication
(10) Pub. No.: US 2026/0190041 A1
(43) Pub. Date: Jul. 2, 2026

(54) UE POWER CLASS FALLBACK IN WIRELESS COMMUNICATION SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 19/349,927

(22) Filed: Oct. 3, 2025

Related U.S. Application Data
(60) Provisional application No. 63/713,379, filed on Oct. 29, 2024.

(51) Int. Cl. H04W 52/36; H04W 72/0446

(52) U.S. Cl. CPC H04W 52/367; H04W 72/0446

(57) ABSTRACT

Apparatuses and methods for transmit power in wireless communication systems. A method for operating a user equipment (UE) includes receiving first information for an uplink (UL) transmission on an UL carrier provided for UL carrier aggregation and receiving second information associated with a UE maximum output power mode for UL carrier aggregation. The method further includes determining, based on the first and the second information, a UE maximum output power for an UL transmission bandwidth on the UL carrier according to a UE power class, determining an UL transmit power based on the UE maximum output power, and transmitting, based on the UL transmit power, an UL signal or channel on the UL carrier.

### CROSS REFERENCE TO RELATED APPLICATIONS AND CLAIM OF PRIORITY

The present application claims priority under 35 U.S.C. § 119 (e) to U.S. Provisional Patent Application No. 63/713,379 filed on Oct. 29, 2024, which are hereby incorporated by reference in their entirety.

### TECHNICAL FIELD

The present disclosure relates generally to wireless communication systems and, more specifically, to user equipment (UE) power class fallback in wireless communication systems.

### BACKGROUND

6th generation (6G) is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

### SUMMARY

The present disclosure relates to UE power class fallback in wireless communication systems.

In one embodiment, a method for operating a UE is provided. The method includes receiving first information for an uplink (UL) transmission on an UL carrier provided for UL carrier aggregation and receiving second information associated with a UE maximum output power mode for UL carrier aggregation. The method further includes determining, based on the first and the second information, a UE maximum output power for an UL transmission bandwidth on the UL carrier according to a UE power class, determining an UL transmit power based on the UE maximum output power, and transmitting, based on the UL transmit power, an UL signal or channel on the UL carrier.

In another embodiment, a UE is provided. The UE includes a transceiver configured to receive first information for an UL transmission on an UL carrier provided for UL carrier aggregation and receive second information associated with a UE maximum output power mode for UL carrier aggregation. The UE further includes a processor operably coupled to the transceiver. The processor is configured to determine, based on the first and the second information, a UE maximum output power for an UL transmission bandwidth on the UL carrier according to a UE power class and determine an UL transmit power based on the UE maximum output power. The transceiver is further configured to transmit, based on the UL transmit power, an UL signal or channel on the UL carrier.

In yet another embodiment, a base station (BS) is provided. The BS includes a processor and a transceiver operably coupled with the processor. The transceiver is configured to transmit first information for an UL transmission on an UL carrier provided for UL carrier aggregation, transmit second information associated with a UE maximum output power mode for UL carrier aggregation, and receive an UL signal or channel on the UL carrier. The UL signal or channel transmitted is based on an UL transmit power that is based on an UE maximum output power for an UL transmission bandwidth on the UL carrier according to a UE power class. The UE maximum output power is based on the first and the second information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example timeline of a separate supported UE power class in a 5G/NR and 6G band combination for a wireless communication system according to embodiments of the present disclosure;

FIG. 11 illustrates an example timeline of a separate UE power class fallback behavior in a 5G/NR and 6G band combination for a wireless communication system according to embodiments of the present disclosure;

FIG. 12 illustrates an example flowchart for a process for a separate UE power class fallback behavior in a 5G/NR and 6G band combination in a wireless communication system according to embodiments of the present disclosure;

FIG. 13 illustrates an example flowchart for a process for a separate joint/common UE power class fallback behavior in a 5G/NR and 6G band combination in a wireless communication system according to embodiments of the present disclosure;

FIG. 14 illustrates an example flowchart for a process for a separate UE power class indication in a 5G/NR and 6G band combination in a wireless communication system according to embodiments of the present disclosure;

FIG. 15 illustrates an example flowchart for a process for a separate joint/common UE power class indication in a 5G/NR and 6G band combination in a wireless communication system according to embodiments of the present; and

FIG. 16 illustrates an example method performed by a UE in a wireless communication system according to embodiments of the present disclosure.

### DETAILED DESCRIPTION

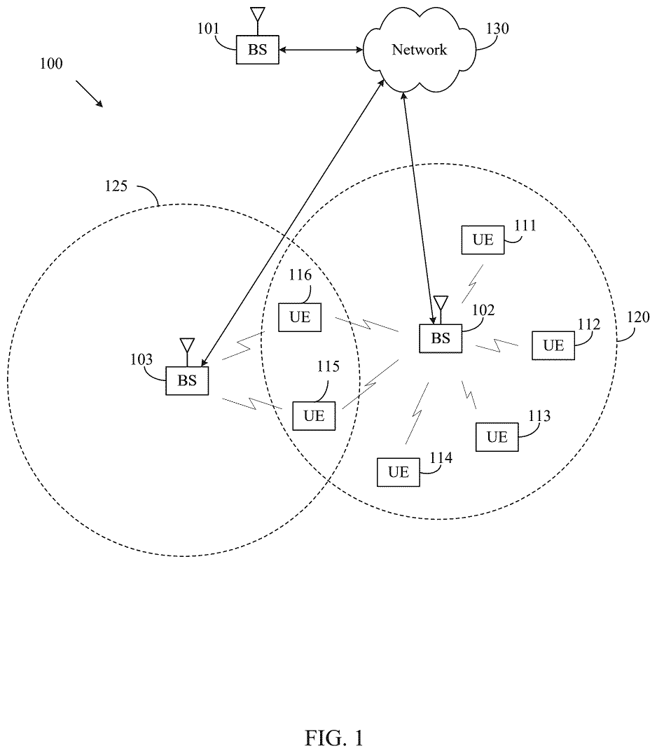

FIGS. 1-16 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G/LTE communication systems, and to enable various vertical applications, 5G/NR communication systems have been developed and are currently being deployed. The 5G/NR communication system can be implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support. 6th generation (6G) cellular communications is recently gathering increased momentum with all the worldwide technical activities on the various candidate technologies from industry and academia. The candidate enablers for the 6G communication system include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may also be applied to deployment of 6G communication systems, to deployment of 5G/NR communication systems, to deployment of 4G/LTE communication systems, or even for deployments which may use terahertz (THz) bands in later releases.

The following documents and standards descriptions are hereby incorporated by reference into the present disclosure as if fully set forth herein: 3GPP TS 38.211 v18.4.0, “NR; Physical channels and modulation” (REF1); 3GPP TS 38.212 v18.4.0, “NR; Multiplexing and Channel coding” (REF2); 3GPP TS 38.213 v18.4.0, “NR; Physical Layer Procedures for Control” (REF3); 3GPP TS 38.214 v18.4.0, “NR; Physical Layer Procedures for Data” (REF4); 3GPP TS 38.321 v18.3.0, “NR; Medium Access Control (MAC) protocol specification” (REF5); 3GPP TS 38.331 v18.3.0, “NR; Radio Resource Control (RRC) Protocol Specification” (REF6); 3GPP TS 38.101-1 v18.7.0, “NR; UE radio transmission and reception; Part 1: Range 1 Standalone” (REF7); 3GPP TS 38.101-2 v18.7.0, “NR; UE radio transmission and reception; Part 2: Range 2 Standalone” (REF8); 3GPP TS 38.101-3 v18.7.0, “NR; UE radio transmission and reception; Part 3: Range 1 and Range 2 Interworking operation with other radios” (REF9); 3GPP TS 38.133 v18.7.0, “NR; Requirements for support of radio resource management” (REF10); 3GPP TS 36.213 v18.2.0, “E-UTRA; Physical Layer Procedures” (REF11); 3GPP TS 38.300 v18.3.0, “NR and NG-RAN Overall Description (Stage 2)” (REF12); 3GPP TS 37.340 v18.3.0, “E-UTRA and NR; Multi-connectivity; Overall Description (Stage 2)” (REF13).

Various of the figures and discussion below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 6G, 5G/new radio (NR), 4G/long term evolution (LTE) or long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station, a macrocell, a femtocell, a WiFi access point (AP), or other wirelessly enabled devices. Base stations may provide wireless access in accordance with one or more wireless communication protocols, e.g., 6G, 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or a vending machine or a fixed wireless access node).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UE power class fallback in a wireless communication system. In certain embodiments, one or more of the BSs 101-103 include circuitry, programing, or a combination thereof to support UE power class fallback in a wireless communication system. Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

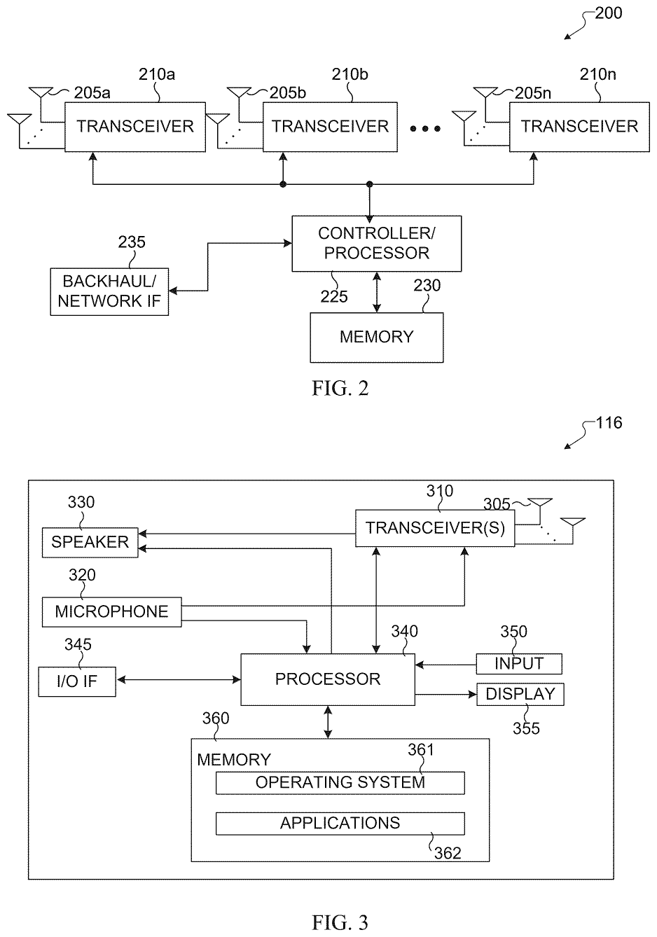

FIG. 2 illustrates an example TRP 200 according to embodiments of the present disclosure. For example, the TRP 200 any be a base station, such as gNB 101-103, or may be an NCR or smart repeater (SR). The embodiment of the TRP 200 illustrated in FIG. 2 is for illustration only. However, TRPs come in a wide variety of configurations, and FIG. 2 does not limit the scope of the present disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235. The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UE power class fallback in wireless communication systems. Any of a wide variety of other functions could be supported in the TRP 200 by the controller/processor 225.

The controller/processor 225 is also capable of executing programs and other processes resident in the memory 230, such as processes to support transmission power in a wireless communication system. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UE power class fallback in wireless communication systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

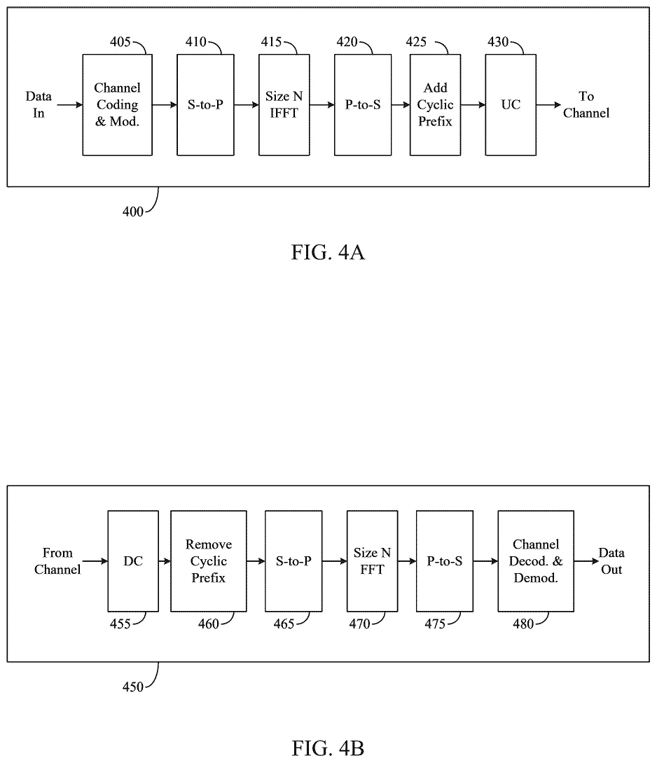

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for operation in a 6G or 5G/NR or 4G/LTE in a wireless communication system as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or the TRP 200 and may implement a receive path 450 for receiving in the downlink from gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

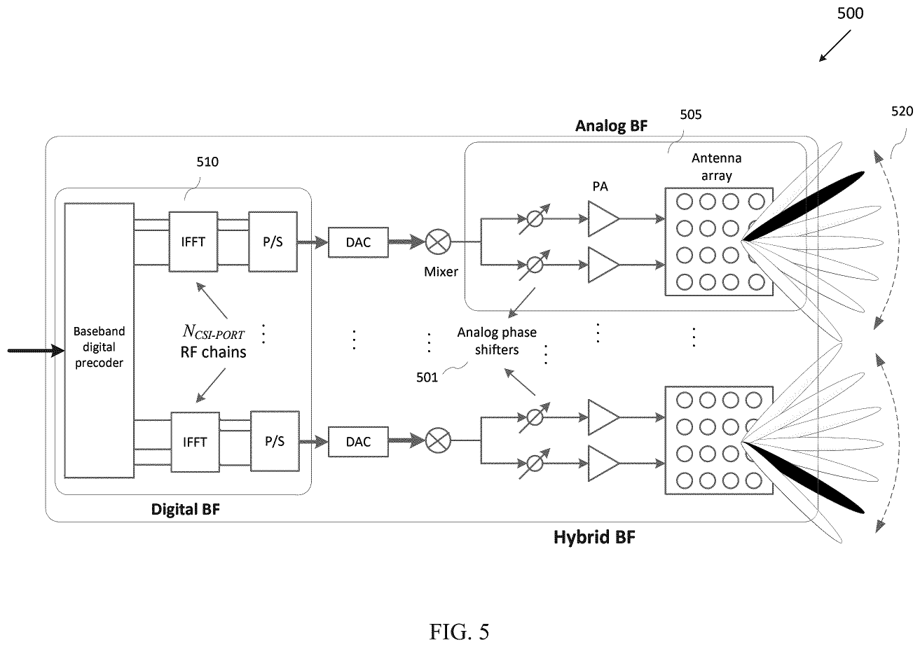

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

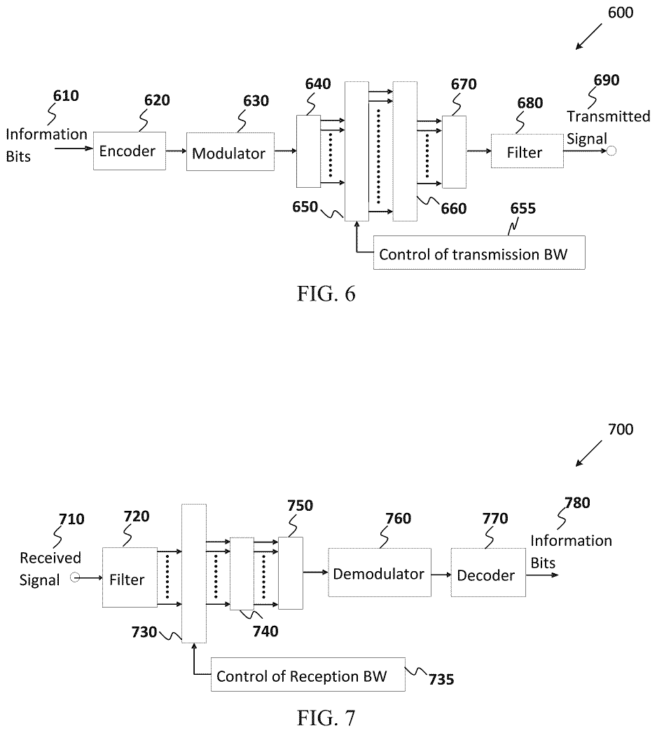

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder or a low-density-parity-check (LDPC) decoder, decodes the demodulated data to provide an estimate of the information data bits 780. Additional functionalities such as time-windowing, cyclic prefix removal, de-scrambling, channel estimation, and de-interleaving are not shown for brevity.

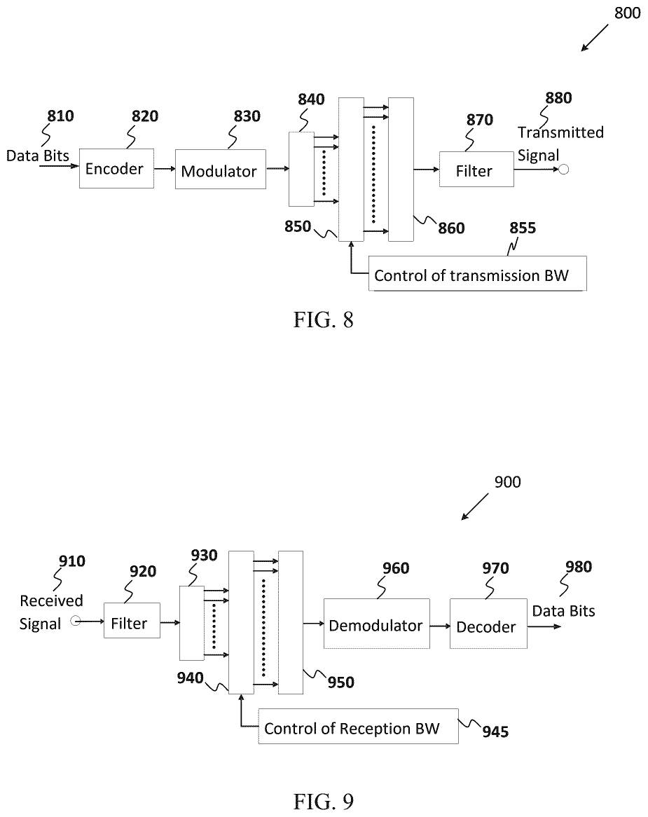

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder or a low-density-parity-check (LDPC) decoder, decodes the demodulated data to provide an estimate of the information data bits 980.

The present disclosure relates generally to wireless communication systems and, more specifically, to UE procedures for UE transmitter power and uplink transmit power control for operation in a wireless communication system.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI/configured scheduling RNTI (CS-RNTI)/modulation and coding scheme (MCS)-C-RNTI as described in REF2, are referred for brevity as a unicast DCI format. A DCI format scheduling PDSCH reception for multicast communication, such as a DCI format with CRC scrambled by group (G)-RNTI/G-CS-RNTI as described in REF2, are referred to as multicast DCI format. DCI formats providing various control information to at least a subset of UEs in a serving cell, such as DCI format 2_0 in REF2, are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA. A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type 1 for a first DL RS, and qcl-Type 2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}. A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is Npr. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, a 6G UE, or a UEs with the same, similar, or more capabilities compared to a Rel-21 6G or a 5G/NR UEs. Although various embodiments of the disclosure discuss 3GPP 6G 5G/NR wireless communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling, or by core network signaling between a UE and a network node.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=20 for Rel-20, or xx=21 for Rel-21, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3 when using 5G/NR.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz” or “6G band 7-8 GHz”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REFS7-9. For example, the term “FR1 4 GHz” may be used interchangeably with a term such as “FR1 band 4 GHz” or “6G band 4 GHz”.

In certain embodiments, 5G/NR or 4G/LTE radio access may be supported on a carrier or in a band of a frequency range corresponding to an FR1 operating band, or 5G/NR radio access may be supported on a carrier or in a band of an FR2 operating band such as defined in REFS7-9 for 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT corresponds to one of 5G/NR radio access or 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access or may also support other wireless radio access.

For example, when operating in dual RAT mode based on principles such as described in REF13 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

The UE (e.g., the UE 116) needs to conform to regulatory requirements such as maximum permissible exposure (MPE) requirements to limit the total RF exposure experienced by a user. RF exposure can fall in two categories. A first category is the specific absorption rate (SAR). SAR applies to frequencies below 6 GHz. SAR is measured in units of Watts/kg and reflects the amount of power absorbed by a certain volume of tissue. A second category is power density (PD) and applies to frequencies above 6 GHz. PD is measured in units of Watts/cm² and reflects the amount of power incident on the surface of tissue. Using Rel-15 NR, SAR is used as metric when taking into account the FR1 band below 6 GHz and PD is used as metric when taking into account the FR2-1 (mm Wave) bands.

For example, requirements from the FCC and the International Commission on Non-Ionizing Radiation Protection (ICNIRP) limit the MPE. Limits on SAR and PD are taken into account jointly. The individual SAR and PD values are normalized by the respective regulatory limits as seen in equation (E1):

$${\sum }_{i = 100 kHz}^{6 GHz} \frac{{SAR}_{i}}{{SAR}_{lim}} + {\sum }_{j = 6 GHz}^{300 GHz} \frac{{PD}_{j}}{{PD}_{lim}} \leq 1 \qquad ( E1 )$$

Here, SARᵢ refers to the time-averaged SAR in an RF band i and is determined according to equation (E2) where SARᵢ(τ) is the instantaneous SAR in band i. PDⱼ refers to the time-averaged PD in band j and is given by equation (E3) where PDⱼ(T) is the instantaneous PD in band j. T_{SAR} and T_{PD} are the time windows for averaging, respectively. SARₗᵢₘ is a total regulatory limit for SAR. PDₗᵢₘ is a total regulatory limit for PD. Note that determination of the SAR and the PD is to include transmissions across frequencies and radio technologies of a UE, e.g., including Wi-Fi, or Bluetooth, or wireless transmission other than cellular radio when present.

$${SAR}_{i} = \frac{1}{{T}_{SAR}} {\int }_{t - {T}_{SAR}}^{t} {SAR}_{i} ( τ ) d τ \qquad ( E2 )$$

$${PD}_{j} = \frac{1}{{T}_{PD}} {\int }_{t - {T}_{PD}}^{t} {PD}_{j} ( τ ) d τ \qquad ( E3 )$$

The PD is typically measured over 4 cm² area and is limited to 1 mW/cm². A time averaging of 4 seconds can be used for frequencies from 24 GHz to 42 GHz. The SAR may be limited to 1.6 W/kg measured over 1 g of tissue. A time averaging window of 360 seconds can be used. Certain aspects of the measurement or evaluation procedure may vary across regulatory domains or countries.

The time averaging is an important UE implementation aspect when the UE monitors the RF exposure limits such as MPE. For example, the UE can monitor its wireless transmissions and determines or estimates the amount of generated RF exposure using a sliding time window for averaging. The UE can then determine an amount of allowable RF exposure such as MPE for a next period of time such as the next several hundred msec or the next 1 sec. The UE then uses an estimated, e.g., an allowable RF exposure limit to determine a maximum output power while adhering to the parameterization and closed-loop power-control commands from the gNB (e.g., the BS 102) according to the UL transmit power control procedure. For example, when an estimated or an allowable RF exposure limit is determined by the UE to be in excess of RF exposure limits, the UE may then use power class fallback or P-MPR based mitigation to reduce the RF exposure below acceptable levels using Rel-15 NR specifications as further described herein.

Using Rel-15 NR, a UE maximum transmit power or maximum output power can depend on a number of factors such as the UE maximum output power or UE power class (PC) and/or a power reduction that a UE is allowed under certain conditions.

A UE power class such as defined in REFS7-9 defines the maximum output power for any transmission bandwidth within the channel bandwidth of an NR carrier for FR1 or defines the maximum output power radiated by the UE for any transmission bandwidth within the channel bandwidth for FR2. For example, a UE power class may be specified or tested based on conducted or cabled measurements in FR1, or based on over-the-air (OTA) measurements in FR2. For example, the period of measurement may be at least one subframe (1 msec). For example, in the case of FR3, a UE power class may be defined according to FR1 for operating frequencies in the range of 6-8 GHz. For example, in the case of FR3, a UE power class may be defined according to FR2 for operating frequencies in the range of 13 GHZ.

Using Rel-15 NR, several UE power classes are defined for FR1, such as power class 1 (PC1), power class 1.5 (PC1.5), power class 2 (PC2), power class 3 (PC3) or power class 4 (PC4). For example, UEs operating within FR1 typically support a maximum output power according to power class 3 (PC3), e.g., 23 dBm, or power class 2 (PC2), e.g., 26 dBm. PC3 may be regarded the default power class for FR1. Power classes 2 or 1.5 may only be applicable to specific operating bands such as applicable in NR bands n78 or n41 but not applicable in NR band n7. PC3 may be applicable for FR1 operating bands.

For example, with reference to 5G/NR and intra-band contiguous or non-contiguous carrier aggregation or inter-band carrier aggregation in FR1, current specifications as defined in REFS7-9 support operation according to PC2 or PC3 wherein PC2 is possible in some band combinations. For example, with reference to 5G/NR and NR inter-band dual-connectivity operation in FR1, current specifications as defined in REFS7-9 support operation according to PC3. For example, with reference to 5G/NR and LTE-NR dual connectivity operation (or EN-DC) in FR1 for the intra-band case, current specifications as defined in REFS7-9 support operation according to PC1.5, PC2 or PC3 wherein PC1.5 or PC2 are possible in some band combinations. For example, with reference to 5G/NR and LTE-NR dual connectivity operation (or EN-DC) in FR1 for the inter-band case, current specifications as defined in REFS7-9 support operation according to PC2 or PC3 wherein PC2 is possible in some band combinations. For example, with reference to 5G/NR and NR-LTE dual connectivity operation (or NE-DC) in FR1 for the inter-band case, current specifications as defined in REFS7-9 support operation according to PC3.

Using Rel-15 NR and for FR2, a maximum equivalent isotropic radiated power (EIRP) limit may be used to satisfy regulatory requirements, i.e. ensuring that the UE does not transmit at such high power that health issues would be caused or excessive interference would be caused. A maximum EIRP takes into account maximum antenna gain which can be generated by the FR2 UE. ‘Mobile’ UEs are specified to have a maximum EIRP of 43 dBm, while ‘transportable’ UEs are specified to have a maximum EIRP of 55 dBm according to REFS7-9. A minimum peak EIRP may be used to ensure that a UE can generate at least a minimum output power in one specific direction. A total radiated power (TRP) for a UE can define an upper limit on the total power radiated in directions. For example, UEs operating within FR2 may support a power class 1, 2, 3 or 4 wherein a power class can correspond to an assumed use case or application which is associated with each UE power class. For example, power class 1 (PC1), e.g., with maximum total radiated power (TRP) of 35 dBm and maximum peak EIRP of 55 dBm is intended for fixed wireless access (FWA) and has the highest transmit power capability. For example, power class 2 (PC2) for vehicular applications, power class 3 (PC3) for handheld UEs and power class 4 (PC4) for high-power non-handheld UEs can have equal maximum TRP of 23 dBm and maximum peak EIRP requirements of 43 dBm but different minimum peak EIRP requirements.

Using Rel-15 NR, a UE may be allowed a power reduction under certain conditions. For example, a first type of power reduction can be allowed for the UE to accommodate higher order modulations and/or transmit bandwidth configurations and may be referred to as maximum power reduction (MPR). A second type of maximum power reduction may be allowed for the UE to meet stringent spectral emission requirements and may be referred to as additional maximum power reduction (A-MPR). A third type of power reduction can be allowed for the UE to accommodate power management maximum power reduction (P-MPR) to comply with MPE requirements. More than one power reduction associated with different types may be applied by the UE for an UL transmission.

An MPR such as defined in REFS7-9 allows the UE to reduce the maximum output power due to higher order modulations and transmit bandwidth configurations. MPR can specify a power back-off for certain NR waveforms such as 16QAM or 64QAM and/or for location of the RBs in the operation band. The UE may not be able to generate and transmit a waveform for the maximum power according to the UE power class while also adhering to adjacent channel leakage ratio (ACLR), in-band emission (IBE), error vector magnitude (EVM) and spectral emission mask (SEM) constraints. For example, MPR values provided in REFS7-9 are chosen such that a UE can still generate a waveform at a reasonable implementation complexity while respecting applicable ACLR, IBE, EVM and/or SEM requirements. For example, an MPR value may be used by the UE to calculate a lower bound on its P_{CMAX,f,c} value. The MPR value numbers may represent the maximum amount of power back-off which is allowed for the UE. The UE may or may not use such a maximum allowance when determining its UL transmit power for an UL transmission for as long as the UE can still meet applicable ACLR, IBE, EVM and/or SEM requirements.

An A-MPR is an additional maximum power reduction allowed for the maximum output power as specified in REFS7-9. For example, the total reduction to the UE maximum output power can be max (MPR, A-MPR). For example, an MPR and/or A-MPR can be based on an outer, inner or edge RB allocation, or a modulation and waveform type, or an associated network signaling label with further details provided in REFS7-9.

A P-MPR is power management maximum power reduction for serving cell. For example, P-MPR may be used by the UE for ensuring compliance with applicable electromagnetic energy absorption requirements such as MPE and/or addressing unwanted emissions or self-de-sense requirements in case of simultaneous transmissions on multiple radio access technologies (RAT(s)) or when proximity detection is used to address such requirements that would require a lower maximum output power. For example, based on the available maximum output transmit power and/or P-MPR of the UE, a gNB may adjust the scheduling decisions. For example, P-MPR may impact the maximum UL performance for the selected UL transmission path.

Using Rel-15 NR, for example, two approaches are for the UE implementation to autonomously reduce its maximum transmit power in order to adjust the UL transmissions according to RF exposure limits such as MPE. One approach is power class fallback when the UE supports a maximum transmit power higher than the default class. Another approach is to use the P-MPR allowance.

For example, using power class fallback, a PC2 UE can indicate to the gNB a maximum UL duty cycle up to which it is able to sustain the output power according to PC2 for its UL transmissions. For FR1, the maximum duty cycle is indicated by the parameter maxUplinkDutyCycle-PC2-FR1 in a UE capability message. When this parameter is not reported by a PC2-capable UE, it is expected to correspond to a default value, e.g., 50%. When UL scheduling occurs using dynamic and/or configured grants and the maximum duty cycle is exceeded, then the UE may operate as a PC3 UE. Similar instances apply to a PC1.5 capable UE. Power class fallback procedures to reduce a UE maximum output power may be used according to conditions such as further specified in REFS7-9. Similarly, P-MPR based behavior may be used by the UE in conjunction with a maximum UL duty cycle to reduce a UE maximum output power as defined in REFS7-9.

In one example for a FR1 PC2 or PC1.5 UE and intra-band contiguous EN-DC operation, if the UE supports a different power class than the default UE power class for the EN-DC band combination, and the supported power class enables higher maximum output power than that of the default power class: if the LTE UL/DL configuration is 0 or 6, or if the LTE UL/DL configuration is 1 and the special subframe configuration is 0 or 5; or if the parameter p-maxUE-FR1-r15 is provided and set to the maximum output power of the default power class or lower; the UE applies the requirements for the default power class and sets the configured transmitted power; else if the UE does not support a power class with higher maximum output power than PC2; or if the LTE UL/DL configuration is not 2 or 4 or 5; or if the field of UE capability max UplinkDutyCycle-PC2-FR1 is absent and the percentage of UL symbols transmitted in a certain evaluation period is larger than 25%, or if the maxUplinkDutyCycle-PC2-FR1 is not absent and the percentage of UL symbols transmitted in a certain evaluation period is larger than 0.5*maxUplinkDutyCycle-PC2-FR1; or if the UE P-Max is provided and set to the maximum output power of the power class 2 or lower; the UE applies requirements for the power class 2 and sets the configured transmitted power; else the UE applies requirements for the supported power class and sets the configured transmitted power class as further specified in REFS7-9.

In one example for a FR1 PC2 UE and inter-band EN-DC within FR1 operation, if a UE supports a different power class than the default UE power class for an LTE TDD and NR TDD inter-band EN-DC band combination and the supported power class enables higher maximum output power than that of the default power class: if the field of UE capability maxUplinkDutyCycle-interBandENDC-TDD-PC2-r16 is absent and the percentage of NR UL symbols transmitted in a certain evaluation period is larger than 30%, or if the field of UE capability maxUplinkDutyCycle-interBandENDC-TDD-PC2-r16 is not absent and the percentage of NR UL symbols transmitted in a certain evaluation period is larger than maxUplinkDutyCycle-interBandENDC-TDD-PC2-r16, or if the IE p-maxUE-FR1 is provided and set to the maximum output power of the default power class or lower, the UE applies requirements for the default power class to the supported power class and sets the configured transmitted power; else if the IE p-maxUE-FR1 is not provided or set to the higher value than the maximum output power of the default power class and the percentage of NR UL symbols transmitted in a certain evaluation period is less than or equal to max UplinkDutyCycle-inter BandENDC-TDD-PC2-r16, or if the IE p-maxUE-FR1 is not provided or set to the higher value than the maximum output power of the default power class and the percentage of NR UL symbols transmitted in a certain evaluation period is less than or equal to 30% when maxUplinkDutyCycle-inter BandENDC-TDD-PC2-r16 is absent, the UE applies requirements for the supported power class and sets the configured transmitted power class as specified in REFS7-9.

In another example for a FR1 PC2 UE and inter-band EN-DC within FR1 operation, if a UE supports a different power class than the default UE power class for an E-UTRA FDD and NR TDD EN-DC band combination and the supported power class enables higher maximum output power than that of the default power class; if the UE indicates the two capabilities max UplinkDutyCycle-FDD-TDD-EN-DC1 and maxUplinkDutyCycle-FDD-TDD-EN-DC2: if the IE p-maxUE-FR1 is not provided or set to the higher value than the maximum output power of the default power class, and the percentage of LTE UL symbols transmitted in a certain evaluation period is between 40% and 70%, and the percentage of NR UL symbols transmitted in a certain evaluation period is less than or equal to max UplinkDutyCycle-FDD-TDD-EN-DC1, or if the IE p-maxUE-FR1 is not provided or set to the higher value than the maximum output power of the default power class, and the percentage of LTE UL symbols transmitted in a certain evaluation period is no larger than 40%, and the percentage of NR UL symbols transmitted in a certain evaluation period is less than or equal to maxUplinkDutyCycle-FDD-TDD-EN-DC2, the UE applies requirements for the supported power class and sets the configured transmitted power class; else the UE applies requirements for the default power class and set the configured transmitted power; else the UE applies requirements for the supported power class and sets the configured transmitted power as specified in REFS7-9.

In one example for a FR1 PC2 UE and inter-band carrier aggregation within FR1 operation, if a UE supports a different power class than the default UE power class for the band combination and the supported power class enables the higher maximum output power than that of the default power class; if the field of UE capability maxUplinkDutyCycle-interBandCA-PC2 is not absent and the average percentage of UL symbols transmitted in a certain evaluation period is larger than maxUplinkDutyCycle-interBandCA-PC2, or if 10 log 10Σ p_{EMAX,c} or P_{EMAX,CA} is 23 dBm or lower; the UE applies requirements for the default power class to the supported power class and sets the configured transmitted power; else the UE applies requirements for the supported power class and set the configured transmitted power (regardless of the average percentage of UL symbols if the field of UE capability maxUplinkDutyCycle-interBandCA-PC2 is absent). The average percentage of UL symbols is defined as 50%×(Duty_{NR, x}/maxDuty_{NR,x}+Duty_{NR, y}/maxDuty_{NR,y}) where Duty_{NR, x}, Duty_{NR, y} may represent the actual percentage of UL symbols transmitted in the same evaluation period for NR Band x and NR Band y, respectively; and where maxDuty_{NR,x}, maxDuty_{NR,y} may represent the field of UE capability max UplinkDutyCycle-PC2-FR1 per band. For NR Band x or NR Band y, if the power class of one or both of the bands within the band combination is power class 2 and the corresponding UE capability maxUplinkDutyCycle-PC2-FR1 is absent; the corresponding maxDuty_{NR,x} or maxDuty_{NR,y} is equal to 50%; else if the band is configured with power class 3; the corresponding maxDuty_{NR,x} or maxDuty_{NR,y} is equal to 100%.

For example, MPR based mitigation behavior may be used by the UE in conjunction with a maximum UL duty cycle to reduce a UE maximum output power as defined in REFS7-9. The UE may indicate or report a parameter maxUplinkDutyCycle-FR2 to the gNB, or a default value for the associated maximum UL duty may be assumed, wherein maxUplinkDutyCycle-FR2 is a UE capability to facilitate electromagnetic power density exposure requirements and may be associated with an FR2 power class.

In one example for a FR2 UE, if the field of UE capability maxUplinkDutyCycle-FR2 is present and the percentage of UL symbols transmitted including any PRACH transmission within any 1 sec evaluation period is larger than max UplinkDutyCycle-FR2, the UE can follow the UL scheduling and can apply P-MPR_{c}. If the field of UE capability maxUplinkDutyCycle-FR2 is absent, the compliance to electromagnetic power density exposure requirements may be ensured by the UE by means of scaling down the power density or by other means, as further specified in REFS7-9.

With reference to detailed NR UL transmit power control procedures according to Rel-15 NR, a UE determines an UL transmission power for PUSCH, PUCCH, SRS, and PRACH transmissions.

Using Rel-15 NR, the NR UL transmit power control is based on a combination of open-loop power control (OLPC) and closed-loop power control (CLPC) components. OLPC includes support for fractional pathloss compensation where the UE estimates a pathloss to a serving gNB, based on measurements for DL signals/channels from the serving gNB, and accordingly adjusts a transmission power. CLPC is based on transmit power control (TPC) commands provided by the gNB where, for example, the gNB may determine values for the TPC commands to the UE based on measurements of the received power for transmissions from the UE. The NR UL power control procedure also supports beam-based power control.

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c} (i, j, q_{d}, l) in dBm in PUSCH transmission occasion i as,

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

P_{CMAX}(·) is the configured maximum UE output power per carrier. P₀(·) corresponds to a normalized target received power level that may be indicated by a serving gNB using one or multiple signaled higher layer parameters. PL(·) corresponds to a pathloss estimate by the UE, for example based on an SSB or a NZP CSI-RS. α (·) is a parameter for fractional pathloss compensation that is indicated by the serving gNB. M_{RB}(·) corresponds to the number of RBs for the PUSCH transmission when adjusting a normalized (per RB and 15 kHz SCS) target receive power. Δ_{TF}(·) may be associated with a modulation scheme and channel-coding rate used for the data information provided by the PUSCH transmission and can be viewed as modeling link capacity such as 80% of Shannon capacity. This term may not be included when determining a PUSCH transmit power and can be applicable only for single-layer UL transmissions. f(·) corresponds to a power adjustment state due to the CLPC component.

The configured maximum output power P_{CMAX,f,c} accounts for the UE power class, a maximum power reduction such as MPR, A-MPR, and/or P-MPR, and is set within the following bounds as described in REFS7-9:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} and$$

$${P}_{CMAX \_ H , f , c} = MIN \{ {P}_{EMAX , c} , {P}_{PowerClass} - Δ {P}_{PowerClass} .$$

Here, P_{EMAX,c} is provided by higher layer provided parameter p-Max or by the field additionalPmax of the higher layer parameter NR-NS-PmaxList, as described in REF6. P_{PowerClass} is the maximum UE power of the applicable UE power class specified in REFS7-9 without taking into account the tolerances specified in REFS7-9. The parameter p-Max (range from −30 . . . 33) is used to limit the UE's transmission power on a carrier frequency and may also be used for the UE to calculate compensation factors during cell (re-)selection in RRC_IDLE and/or RRC_INACTIVE states. p-Max is the maximum transmit power allowed in a serving cell with value in dBm.

In addition to limiting a UE transmit power on a serving cell, a total UE transmit power over serving cells for the UE may also be limited. Such a limitation of the UE transmit power over multiple UL carriers may also apply in case of LTE/NR dual connectivity. For example, a maximum transmit power that the UE may use on a serving cell may then be additionally limited by parameters p-NR-FR1 configured for the cell group and p-UE-FR1 configured total power for serving cells operating on FR1. If absent, the UE applies the maximum power according to REFS7-9 in case of an FR1 cell or an FR2 cell. Further details are described in REFS7-9.

The sum P₀(·)+α(·)PL(·) is associated with OLPC and, for α(·)<1, it includes fractional pathloss compensation. For full pathloss compensation (β(·)=1), OLPC adjusts the PUSCH transmit power such that the received power aligns with the target received power P₀(·). For example, P₀(·) may be selected and indicated by the gNB to the UE depending on the target data rate and/or the noise and interference level experienced at the gNB receiver for the UE. For fractional pathloss compensation (α(·)<1), pathloss is not fully compensated while interference to neighbor cells is reduced. The gNB received power for transmissions from a UE may, on average, vary depending on the UE location within the serving cell. For example, for partial pathloss compensation, PUSCH transmissions from UEs experiencing larger pathloss, due to being at larger distances from the gNB, may be received by the gNB with lower power that PUSCH transmissions from UEs experiencing smaller pathloss. The gNB may compensate by adjusting the UL data rate of UEs accordingly and operate UEs located closer to the gNB with larger data rates than UEs located further from the gNB. In consequence, there may be larger variations in the service quality and reduced data rate availability for UEs further from the gNB (closer to the cell border) when using fractional pathloss compensation.

NR UL transmit power control procedures support beam-based power control. For example, a UE can be configured multiple DL reference signals for pathloss measurements, multiple OLPC parameter sets, and multiple CLPC processes.

In the case of beamforming, a pathloss estimate PL(·) that a UE uses to determine a transmit power should reflect the path loss, including the beamforming gains, of the paired UL beam that the UE uses to transmit a PUSCH. When DL/UL beam correspondence is assumed, the UE can estimate the pathloss based on measurements for a DL reference signal that is transmitted by the gNB over the corresponding paired DL beam. As the UL beam used for UL/DL beam pair may change across PUSCH transmissions, the UE may need to maintain multiple pathloss estimates corresponding to different candidate UL/DL beam pairs. The gNB can configure the UE with a set, such as up to 4, of DL reference signals for pathloss measurements, such as SSBs and/or NZP CSI-RSs. The gNB can also configure a mapping among SRS resource indicator (SRI) values and pathloss DL reference signals. A DCI format scheduling a PUSCH transmission can include a SRI field indicating one of the SRI values and the UE uses a pathloss estimate obtained from the DL RS associated with the indicated SRI value to determine a pathloss value to apply for the determination of the transmit power for the PUSCH transmission.

A UE can be configured multiple, such as up to 30, OLPC parameter sets {P₀(·), α(·)}, each corresponding to a pair of values for a normalized target receive power level and a fractional pathloss compensation coefficient. A UE may use parameter pair {P₀(1), α(1)} for PUSCH transmissions associated with configured grants while remaining parameter pairs are associated with PUSCH transmissions scheduled by DCI formats. The gNB may associate each value of the SRI field in a DCI format with one of the indicated OLPC parameter set pairs. For example, the gNB may select and indicate an OLPC parameter set using separate values for normalized target receive power level and fractional pathloss compensation coefficient, respectively, for each UL beam that can be used by the UE to transmit a PUSCH. For a PUSCH transmission before the UE receives dedicated configuration for OLPC parameters, such as for a Msg3 PUSCH transmission or for a PUSCH transmission scheduled by a DCI format with CRC scrambled by a temporary C-RNTI (TC-RNTI), fractional power control is not used, e.g., α(·)=1, and P₀(·) may be determined by the UE based on received information in the configuration of the random-access procedure.

With respect to multiple OLPC parameter sets, NR supports for a UE (e.g., the UE 116) to be configured with up to three values for the normalized target receive power P₀(·) resulting to up to three respective values for a PUSCH transmit power. A DCI format scheduling the PUSCH transmission can indicate one of the P₀(·) values for the UE to use in determining a power for the PUSCH transmission. For example, a DCI format 0_1 or a DCI format 0_2 may be configured to include a OLPC parameter set indication field and its associated index values are indicated by higher layer signaling such parameter P0-PUSCH-Set-r16 as described in REF2 and REF6. The OLPC parameter set indication field has length of 1 bit when the DCI format scheduling the PUSCH transmission also includes the SRI field and has length of 1 bit or 2 bits when the SRI field is not present. It is noted that the OLPC parameter set indication field indicates only the normalized target receive power setting P₀(·) and does not indicate the fractional pathloss coefficient α(·).

A UE can be configured with two SRS resource sets. Values of two SRS resource set indicator fields in a DCI format scheduling a PUSCH transmission can indicate a first and a second normalized target receive power P₀(·) from a first and a second OLPC parameter set p0-PUSCH-Alpha and p0-PUSCH-Alpha2, respectively, that is provided by higher layers. Determination of the target receive power and fractional pathloss compensation coefficient by the UE is per SRI field as in the case of a single SRI field in the DCI format.

Furthermore, the UE can be configured with multiple, such as 2, independent CLPC processes. Similar to having multiple pathloss DL reference signals and multiple OLPC parameter sets, the selection of the associated CLPC process by the UE can be configured by higher layers for the SRI value indicated by the DCI format.

The corresponding UL transmit power procedures for the cases of other UL channels or signals such as PUCCH, SRS or PRACH are further described in REF3.

With reference to detailed 5G/NR procedures for single cell operation with two uplink carriers or for operation with carrier aggregation or for operation with a candidate cell configured by LTM-Config, if a total UE transmit power for PUSCH or PUCCH or PRACH or SRS transmissions on serving cells or on a candidate cell, if any, in a frequency range in a respective transmission occasion i would exceed \hat{P}_{CMAX}(i), where \hat{P}_{CMAX}(i) is the linear value of P_{CMAX}(i) in transmission occasion i as defined in REFS7-9, the UE allocates power to PUSCH/PUCCH/PRACH/SRS transmissions according to a certain priority order so that the total UE transmit power for transmissions on serving cells or on a candidate cell, if any, in the frequency range is smaller than or equal to \hat{P}_{CMAX}(i) for that frequency range in every symbol of transmission occasion i.

A descending priority order from higher to lower priority is defined by system operating specifications in REF3 according to: (1) a PRACH transmission on a candidate cell; (2) a PRACH transmission on the PCell; (3) PUCCH or PUSCH transmissions with larger priority index; (4) for PUCCH or PUSCH transmissions with same priority index a PUCCH transmission with HARQ-ACK information, and/or SR, and/or LRR, or a PUSCH transmission with HARQ-ACK information of the priority index, PUCCH or PUSCH transmission with CSI, PUSCH transmission without HARQ-ACK information of the priority index or CSI and, for Type-2 random access procedure, PUSCH transmission on the PCell; (5) if the UE is configured with a parameter prioSCellPRACH-OverSP-PeriodicSRS-r17, aperiodic SRS transmission or PRACH transmission on a serving cell other than the PCell, semi-persistent and/or periodic SRS transmission; and (6) otherwise an SRS transmission, with aperiodic SRS having higher priority than semi-persistent and/or periodic SRS, or a PRACH transmission on a serving cell other than the PCell.

In case of same priority order and for operation with carrier aggregation, the UE may prioritize power allocation for transmissions on the primary cell of the MCG or the SCG over transmissions on a secondary cell. In case of same priority order and for operation with two UL carriers, the UE may prioritize power allocation for transmissions on the carrier where the UE is configured to transmit PUCCH. If PUCCH is not configured for any of the two UL carriers, the UE may prioritize power allocation for transmissions on the non-supplementary UL carrier. Further details are described in REF3.

With reference to detailed 5G/NR procedures for dual connectivity operation, the UE may be configured with a maximum transmission power for transmissions on an MCG or an SCG wherein the MCG or the SCG may operate according to 4G/LTE or to 5G/NR.

For example, if a UE is configured with an MCG using LTE radio access and with an SCG using NR radio access, i.e., EN-DC operation or LTE-NR dual connectivity operation, the UE is configured a maximum power P_{LTE} for transmissions on the MCG by parameter p-MaxEUTRA and a maximum power P_{NR} for transmissions in FR1 on the SCG by p-NR-FR1. The UE determines a transmission power for the MCG according to REF11 using P_{LTE} as the maximum transmission power. The UE determines a transmission power for the SCG in FR1 or FR2 as described in REF3 using P_{NR} as the maximum transmission power. Certain limitations may apply with respect to an LTE configuration. For example, the UE does not expect to be configured for operation with the LTE shortened TTI and/or processing time features on a cell that is included in an EN-DC configuration.

If a UE is configured with

$${\hat{P}}_{LTE} + {\hat{P}}_{NR} > {\hat{P}}_{Total}^{EN - DC} ,$$

where \hat{P}_{LTE} is the linear value of P_{LTE}, \hat{P}_{NR} is the linear value of P_{NR}, and

$${\hat{P}}_{Total}^{EN - DC}$$

is the linear value of a configured maximum transmission power for EN-DC operation as defined in REFS7-9, the UE may determine a transmission power for the SCG as follows. Note that if the UE does not indicate a capability for dynamic power sharing between LTE and NR for EN-DC, the UE expects to be configured with a reference TDD configuration for 4G/LTE by parameter tdm-PatternConfig according to REF11.

If the UE is configured with a reference TDD configuration for LTE by a parameter tdm-PatternConfig or by tdm-PatternConfig2 in REF11: if the UE does not indicate a capability for dynamic power sharing between LTE and NR for EN-DC, the UE does not transmit in a slot on the SCG in FR1 when a corresponding subframe on the MCG is an UL subframe in the reference TDD configuration; if the UE indicates a capability for dynamic power sharing between E-UTRA and NR for EN-DC, and does not indicate a capability tdm-restrictionDualTX-FDD-endc-r16, and is configured with tdm-PatternConfig2, the UE does not transmit on the SCG in FR1 when the UE has overlapped transmission on a subframe on the MCG.

If the UE indicates a capability for dynamic power sharing between LTE and NR for EN-DC and if UE transmission(s) in subframe i₁ of the MCG overlap in time with UE transmission(s) in slot i₂ of the SCG in FR1, and if

$${\hat{P}}_{MCG} ( {i}_{1} ) + {\hat{P}}_{SCG} ( {i}_{2} ) > {\hat{P}}_{Total}^{EN - DC}$$

in any portion of slot i₂ of the SCG, the UE reduces transmission power in any portion of slot i₂ of the SCG so that

$${\hat{P}}_{MCG} ( {i}_{1} ) + {\hat{P}}_{SCG} ( {i}_{2} ) \leq {\hat{P}}_{Total}^{EN - DC}$$

in any portion of slot i₂, where \hat{P}_{MCG}(i₁) and \hat{P}SCG(i₂) are the linear values of the total UE transmission powers in subframe i₁ of the MCG and in slot i₂ of the SCG in FR1, respectively. The UE is not required to transmit in any portion of slot i₂ of the SCG if \hat{P}_{SCG}(i₂) would need to be reduced by more than the value provided by X_{SCALE} in order for

$${\hat{P}}_{MCG} ( {i}_{1} ) + {\hat{P}}_{SCG} ( {i}_{2} ) \leq {\hat{P}}_{Total}^{EN - DC}$$

in any portion of slot i₂ of the SCG. The UE is required to transmit in slot i₂ of the SCG if \hat{P}_{SCG}(i₂) would not need to be reduced by more than the value provided by X_{SCALE} in order for

$${\hat{P}}_{MCG} ( {i}_{1} ) + {\hat{P}}_{SCG} ( {i}_{2} ) \leq {\hat{P}}_{Total}^{EN - DC}$$

in all portions of slot i₂.

Further details for the case of NE-DC operation, i.e., NR-LTE dual connectivity operation, or for the case of NR-DC operation, i.e., NR-NR dual connectivity operation, are defined in REF3.

When considering UE procedures for UE transmitter power and UL transmit power control for operation in wireless communications systems, several issues related to limitations and drawbacks of existing technology need to be overcome in order to increase the UE communications range, or to increase the UE data throughput rate, or to improve system operation according to channel conditions.

It needs to be considered that for receptions in the UL by a gNB in a network deployment supporting one or more RATs in one or more bands, a different number of receiver antennas or panels, a different effective receive antenna aperture area, or a different receive antenna directivity setting may be available for receptions in a first band corresponding to the first RAT, e.g., 6G radio access, and for receptions in the second band corresponding to the second RAT, e.g., 5G/NR radio access, when compared to receptions in a same band. An antenna or panel configuration in either or both bands at the gNB may not be known to a UE. Similar considerations may be applied with respect to transmissions in the DL from the gNB.

For example, the network deployment may support a 16 TRX panel with 64 antenna elements in a panel in an FR1 band such as n3/n7 for 5G/NR radio access, or may support a 64 TRX panel with 128 antenna elements in a panel in an FR1 band such as n77/78 for 5G/NR radio access, or may support a 256 TRX panel with 768 antenna elements in a panel in an FR3 band such as 7-8 GHz for 6G radio access.

Furthermore, the processing gain and a corresponding received signal-to-noise/interference ratio of an UL signal/channel may not be the same for receptions in the first and the second RATs, respectively. It can be expected that 6G radio access can improve upon the demodulation and multiplexing performance of 5G/NR radio access due to aspects such as advances in signal/channel design, or multiplexing, or channel coding, or beamforming, or multiple-antenna operation, or modem processing, or AI/ML.

It needs to be considered that a network loading and the corresponding interference levels experienced by the gNB receiver may differ between receptions in the first band corresponding to the first RAT, e.g., 5G/NR radio access, and the second band corresponding to the second RAT, e.g., 6G radio access, respectively.

For example, it may be expected that a network loading in FR1 bands such as n1, or n3 or n7 in 2 GHz bands using 5G/NR radio access is initially higher than a network loading in an FR3 band such as 7-8 GHz. A factor is an initially expected low penetration or availability rate of UEs supporting 6G radio access and a continued use of 5G/NR radio access in the 5G/NR bands of the deployment. For example, it can be expected, that network loading and corresponding interference levels experienced by the gNB receiver in the second band corresponding to 6G radio access may increase over time as penetration rate or availability of 6G capable UEs increase. For example, it can be expected that network loading and corresponding interference levels in the 5G/NR band and the 6G band, respectively, may vary depending on network processing capabilities and operator deployment considerations.

Therefore, the resulting signal reception and/or interference power levels and their variation experienced by the gNB receiver may not be same for reception of a signal/channel in the first band corresponding to the first RAT when compared to reception of the signal/channel in the second band corresponding to the second RAT. For example, a UE transmission power for UL transmissions from the UE may not be same for a signal/channel in the first band corresponding to the first RAT when compared to UL transmission by the UE of the same signal/channel in the second band corresponding to the second RAT even if a same receive operating SINR target value for UL reception in the first and the second band would apply.

Using existing technology, a first issue relates to a maximum UL duty cycle, or a UE power class fallback behavior, or an MPR based mitigation behavior according to the existing 4G/LTE or 5G/NR specifications, for example to ensure compliance with the applicable electromagnetic energy absorption requirements based on MPE requirements or unwanted emissions or self-de-sense requirements.

Using existing technology, an FR1 UE can support a different power class such as PC2 or PC 1.5 enabling a higher maximum output power than a default PC such as PC3 in a band for single carrier operation or for carrier aggregation or dual connectivity in a band combination. Note that for dual RAT mode based on dual connectivity, e.g., for EN-DC with 4G/LTE radio access on the PCG and 5G/NR radio access on the SCG, the UE can indicate or declare support for one EN-DC power class in a certain band combination. Similar principles apply to other dual connectivity cases such as NE-DC or NR-NR. Use of a higher than default maximum output power in a band can increase the UL coverage or the UL throughput of the UE. A higher supported maximum output power than enabled by the default PC may be employed by the UE if the number of UL symbols for UL transmissions in a period do not exceed a certain supported (or a default) maximum UL duty cycle.

In one example, a UE indicating or declaring support for PC2 for the inter-band EN-DC DC_3A-n78A (two-bands) band combination using existing technology is considered. 4G/LTE radio access is used for the FDD LTE band 3 (1800 MHz), and 5G/NR radio access is used for the TDD NR band 78 (3500 MHz). For example, a supported or a default maximum UL duty cycle for an indicated or supported UE power class may be expressed as the percentage X of UL symbols in a certain evaluation period. For example, X=50% for PC2. When the UE is configured or indicated for a number of UL transmissions in a period in the first band, i.e., using 4G/LTE, and exceeds the supported or default maximum UL duty cycle, the UE would then autonomously reduce its maximum output power in both the first band using 4G/LTE radio access and the second band using 5G/NR radio access in the band combination based on the existing UE power class fallback procedure. For example, a UE supporting EN-DC PC2, or 26 dBm, may then employ power-class fallback and accordingly reduce the UE maximum output power according to the default EN-DC PC3, or 23 dBm, for both the 4G/LTE band and the 5G/NR band.

It needs to be considered that 5G/NR and/or 4G/LTE define one combined UE power class for such FR1 carrier aggregation or dual connectivity band combinations in existing technology. One reason for the single power class approach in existing technology is a typically small frequency separation across the span of the existing FR1 5G/NR and/or 4G/LTE for the inter-band carrier aggregation or dual connectivity band combinations. Such considerations are different for the case of NR FR1-FR2 band combinations which can be separated by a frequency separation of 15 GHz or more and where an FR1 UE power class and an FR2 UE power class are defined differently, i.e., with respect to maximum output power in FR1 but with respect to an EIPR/radiated power in FR2. A notion of single or same UE power Class across FR1 and FR2 is not defined.

Using existing technology, the UE power class fallback behavior for 6G radio access in FR1 or FR3 would then be applied indiscriminately with respect to the first or the second band in a dual RAT band combination. When a maximum output power is reduced due to a higher UL duty cycle in the first band for the MCG, i.e., in a lower band using 5G/NR radio access, a maximum output power is then also correspondingly reduced for the second band for the SCG, i.e., in a higher band using 6G radio access. This is undesirable because the achievable UL coverage or UL throughput of the dual RAT UE supporting 6G radio access may then be accordingly reduced in the higher band using 6G radio access. A use of a same CA or DC power class for a band combination and a corresponding same power class fallback behavior by the UE is less motivated for FR1 and FR3 when considering the wider available frequency separation between an FR1 low-band or mid-band, e.g., for 5G/NR radio access, and an FR3 band such as 7-8 GHZ, e.g., for 6G radio access, when compared to the existing FR1 band combinations for inter-band CA, or EN-DC DC, or NR-NR DC. A wider frequency separation between FR1 and the FR3 bands can reduce a need to employ a power reduction or maximum output power restrictions in a band to maintain an UL transmission signal quality or to reduce a DL demodulation performance degradation potentially arising from RF constraints such as 2^{nd} or 3^{rd} order intermodulation products. This can enable RF operation by the UE subjected to fewer constraints in FR1 and FR3, respectively. Similar considerations can be applied to other cases such as NR-NR dual-connectivity or dual-active protocol stack operation for dual RAT UEs supporting 5G/NR and 6G radio access in FR1 and FR3, respectively.

Using existing technology, a second issue relates to the gNB scheduling and reduced spectral efficiency during system operation. The gNB may not become instantly aware of when and why and under which conditions a dual RAT UE applies a power class fallback or MPR based mitigation behavior in the network deployment with 6G.

For example, the gNB may attempt to count or to track a number or scheduled or configured UL symbols for the UE in the first or the second bands to determine an UL duty cycle for the UE. However, RF exposure such as MPE is autonomously estimated by the UE and can also depend on other factors such as other concurrently active radio transmitters in the UE implementation, an orientation of the device, or an evaluation period over which MPE is assessed by the UE, all of which may be unknown to the gNB. Furthermore, when the UE does not transmit using high output power or hasn't reached the maximum output power according to its power class, the UE may not apply power class fallback behavior even if the maximum duty cycle is exceeded. Using existing technology, autonomy is given to the UE implementation and in consequence, the ability of the gNB to accurately estimate an available UL transmit power from the UE for a particular UL scheduling or UL transmission instance is reduced.

For example, using power class fallback or MPR based mitigation behavior according to existing technology, the UE can reduce its maximum output power to avoid exceeding an RF exposure limit such as MPE in a period of time. The UE may use power class fallback or MPR based mitigation in conjunction with a certain UL duty cycle, e.g., based on an observed or an estimated UL scheduling activity. Using existing Rel-18 NR specifications when operating in FR2, a P-MPR indication can be provided by the UE to the gNB. For example, using power headroom reporting (PHR) in a MAC CE, a UE can report its instantaneous transmit power to transmit a PUSCH. The PHR can include a power headroom value of 6 bits, a P_{CMAX,f,c} value of 6 bits, and a P-MPR value of 2 bits. The power headroom value reflects an amount of additional transmit power a UE can support when compared to the current PUSCH transmit power level. P_{CMAX,f,c} reflects the corresponding maximum power a UE could support. The P-MPR value indicates a range within which a P-MPR was autonomously applied by the UE to the current transmission. However, the PHR can only provide information reactively, e.g., after the fact. Future UE behavior, including a future adjustment of the MPR based mitigation behavior by the UE cannot be inferred by the gNB. Similar considerations apply to UE power class fallback behavior, i.e., future UE behavior with respect to the maximum output power determined by the UE for an UL transmission instance in a period may not be accurately known or predicted by the gNB.

Therefore, existing technology is insufficient to control or adjust the UE transmitter power and perform the UL transmit power control when operating in a wireless communication system.

Accordingly, embodiments of the present disclosure recognize that there is a need for separate control and/or adjustment of the UE transmitter power and UL transmit power control for bands using the 6G radio access and the 4G/LTE or the 5G/NR radio access, respectively, while ensuring compliance with applicable electromagnetic energy absorption requirements such as MPE and/or unwanted emissions or self-de-sense requirements.

Various embodiments of the present disclosure provide separate supported UE power classes (instead of one same UE power class) for the FR1 5G/NR band and the FR3 6G band, respectively, in a band combination with carrier aggregation, dual connectivity or dual stack operation Various embodiments of the present disclosure provide separate UE power class fallback behavior in the FR1 5G/NR band and the FR3 6G band, respectively, in the band combination. Various embodiments of the present disclosure provide for a UE power class indication from the gNB to the UE to set or adjust a same, separate, or separate joint/common fallback behavior for the FR1 5G/NR band and the FR3 6G band, respectively, in the band combination. Various embodiments of the present disclosure provide for a UE power class indication provided from the gNB to the UE based on request PC, priority levels, associated with conditions, duration, activation timing, etc. Various embodiments of the present disclosure provide separate supporting signaling aspects for UE capability, UE assistance and embodiments of the present disclosure. Various embodiments of the present disclosure provide power headroom reporting triggered by UE power class fallback behavior or UE power class.

In one embodiment the UE indicates or reports a first supported UE power class associated with UL transmissions corresponding to 5G/NR radio access in an FR1 band and a second supported UE power class associated with UL transmissions corresponding to 6G radio access in an FR3 band, respectively, for a band combination.

In a variant, the UE indicates or reports a first supported UE power class associated with UL transmissions corresponding to 5G/NR radio access in a first FR1 band and a second supported UE power class corresponding to 6G radio access in a second FR1 band in a band combination, respectively.

In a variant, the UE indicates or reports a first supported UE power class associated with UL transmissions corresponding to 6G radio access in a first FR3 band and a second supported UE power class corresponding to 6G radio access in a second FR3 band in a band combination, respectively.

Separately indicated or reported supported UE power classes with respect to 5G/NR radio access and 6G/NR radio access, e.g., a first supported UE power class for an FR1 band and a second supported UE power class for an FR3 band in a band combination, may correspond to a same or to different power classes. For example, a UE may indicate or report a first supported UE power class for FR1 corresponding to Class 2 but a second supported UE power class for FR3 corresponding to Class 3. For example, a first supported UE power class for FR1 and a second supported UE power class for FR3 may both correspond to Class 2. For example, the UE may indicate or report a first supported UE power class for FR1 corresponding to Class 1.5 with respect to 5G/NR radio access but a second supported UE power class for FR1 with respect to 6G radio access corresponding to Class 2.

The supported UE power class or Classes for a band in a band combination for 5G/NR radio access and for 6G radio access, respectively, e.g., a first and a second supported UE power class, may be indicated or reported separately, e.g., based on separate information fields, values, or an index representative thereof, or jointly, e.g., based on a combined information field, value or set, or an index representative thereof. The first and the second indicated or reported UE power class may correspond to a same power class or may correspond to different power classes. In both cases, e.g., when the first and the second indicated UE power class are same or when different power classes are associated with 5G/NR radio access and 6G radio access, respectively, for a band in a band combination, wherein one of the bands may use 6G radio access, a same or a separate power class fallback behavior can be applied as further described by the embodiments. A first or a second supported UE power class associated with UL transmissions in a first band based on 5G/NR radio access and a second band based on 6G radio access, respectively, in a band combination comprising carriers from FR1 and/or FR3 bands, may be indicated or tabulated or provided by system operating specifications.

A supported UE power class for a UE supporting 6G radio access in a band of a band combination may correspond to a default power class, e.g., UE power class 3. The absence of a field or value indicative of a supported UE power class other than the default power class in the corresponding UE radio access capability parameters for a UE may imply that the UE supports the default power class associated with a UE power class for UL transmissions in a carrier or in a band of the band combination. A default UE power class for a first band corresponding to 5G/NR radio access and a second band corresponding to 6G radio access, respectively, in a band combination, may be same or correspond to different default power classes. Alternatively, a supported UE power class in the carrier or the band for 5G/NR radio access and for 6G radio access, respectively, or for a first band and a second band, respectively, wherein one of the bands corresponds to 6G radio access may be separately indicated or signaled by the UE as a value or a setting in the UE radio access capability parameters.

In one example, a default power class for a band corresponding to 5G/NR radio access may correspond to Class 2 and a default power class for band corresponding to 6G radio access may correspond to Class 3 in the band combination. In another example, the default power class for 5G/NR radio access and for 6G radio access may both correspond to Class 3 for a band combination.

An operational use or an availability of a first or a second supported UE power class associated with UL transmissions in a first band and a second band by the UE, respectively, in a band combination, wherein one of the bands corresponds to 6G radio access may be further associated or be subject to conditions or restrictions as described by the embodiments.

A first or a second supported UE power class associated with UL transmissions on a carrier in a band corresponding to 6G radio access may be separately indicated or reported for the carrier in the band when a serving cell on the carrier is indicated for single carrier operation, or for a carrier in a band of a band combination associated with carrier aggregation, or with dual connectivity operation, or with dual active protocol stack operation.

In one example, the UE indicates or reports a first supported UE power class associated with UL transmissions on a carrier in a band when a serving cell is indicated for 6G radio access and the UE indicates or reports a second supported UE power class on the carrier in the band when the serving cell is indicated as part of a band combination for carrier aggregation operation or for dual connectivity operation, or for dual active protocol stack operation.

For example, a UE may indicate or report a first supported UE power class for a carrier in an FR3 band corresponding to Class 2 when a serving cell using 6G radio access is indicated for single carrier operation but a second supported UE power class may correspond to Class 3 when the serving cell is indicated as part of a band combination for carrier aggregation or for dual connectivity or for dual active protocol stack operation.

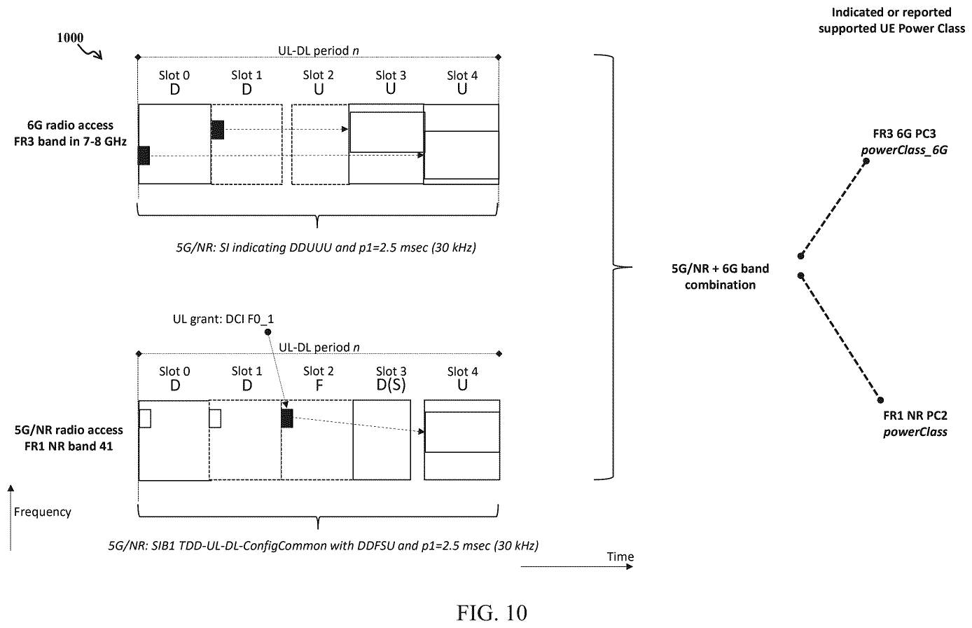

FIG. 10 illustrates an example timeline 1000 of a separate supported UE power class in a 5G/NR and 6G band combination for a wireless communication system according to embodiments of the present disclosure. The timeline 1000 of FIG. 10 can be utilized or followed by any of the UEs 111-116 of FIG. 1, such as the UE 116 of FIG. 3, and any of the BSs 101-103 of FIG. 1, such as BS 102 of FIG. 2. The timeline 1000 is for illustration only and other embodiments can be used without departing from the scope of the present disclosure.

In one example and with reference to FIG. 10, the UE supports a separate UE power class (PC) associated with UL transmissions in a first band corresponding to 5G/NR radio access in FR1 and in a second band corresponding to 6G radio access in FR3, respectively, in a band combination. For simplicity of description and illustration purposes and without loss of generality, the example of a UE on a first carrier corresponding to 5G/NR radio access using FR1 NR band 41 and on a second carrier corresponding to 6G radio access in the FR3 7-8 GHz band is considered. The UE supporting 6G radio access indicates or reports a first supported UE power class, i.e., PC2, to the gNB as the power class the UE supports for UL transmissions when operating on the NR band 41 according to this band combination using a parameter powerClass comprised in UE radio access capability parameters. The UE indicates or reports a second supported UE power class, i.e., PC3 to the gNB as the power class the UE supports for UL transmissions in the 6G band 7-8 GHz according to the band combination using a parameter powerClass_6G. For a power class, the UE may indicate or report to the gNB an associated supported UL duty cycle as the maximum percentage of symbols during a certain evaluation period that can be scheduled for UL transmission to ensure compliance with applicable electromagnetic energy absorption requirements provided by regulatory bodies.

A motivation is that support for separate UE power classes by a UE for an FR1 band using 5G/NR radio access and an FR3 band using 6G radio access in a band combination by a UE can enable separate control and adjustment of the UE maximum output power, for example based on an associated power class fallback behavior when a maximum or a default UL duty cycle value is exceeded during UL transmission in the 5G/NR band and in the 6G band of the band combination, respectively. This can benefit the achievable UL coverage or UL data rate for a UE supporting 6G radio access.

For example, when UL transmissions for the UE are preferably scheduled or configured by the gNB in the FR3 6G band 7-8 GHz where less interference may be incurred due to a reduced loading or where lower target receive power settings may be employed than in the FR1 5G/NR band, it may be preferable to not reduce the UE maximum output power in the FR3 6G band and rather apply a power class fallback, if needed, to the FR1 5G/NR band first. This is because for some FR3 mMIMO antenna configurations, more SINR per slot/symbol may be collected by the gNB than in the FR1 band. If the UE reduces a maximum output power based on PC fallback mitigation procedures, for example to comply with electromagnetic energy absorption requirements, the maximum output power in the FR3 6G 7-8 GHz band should preferably be reduced last. An UL coverage or an UL throughput for the UE can then be improved in the 6G band. Existing technology would reduce the UE maximum output power in both bands of the band combination according to the same UE power class fallback behavior which is undesirable.

In another example, it may be more advantageous to use the supported UE maximum output power for UL transmissions from the UE on the carrier in the FR1 5G/NR band such as when PUSCH repetition in an FR1 5G/NR FDD lower band is configured for a UE at cell edge or in low SINR operating conditions. When a UE maximum output power is reduced by the UE according to a power class fallback procedure for the FR1-FR3 band combination, for example to comply with electromagnetic energy absorption requirements, it may be preferable to maintain the supported UE maximum output power for the FR1 5G/NR lower band providing coverage, and separately adjust or reduce a UE maximum output power for the FR3 6G higher band used as capacity booster where the use of a lower than supported UE power class may result in reduced impact, for example when the cells for FR1 and FR3 are not co-located and the UE is closer to the gNB using FR3 providing data capacity and is further away from the gNB using FR1 providing coverage. Using existing technology for UEs based on dual connectivity operation, for example the gNB may reduce UL scheduling activity on the FR3 6G band in the band combination for the UE, to reduce a contribution to the UL duty cycle from the FR3 6G band, but the UE autonomous behavior in existing technology with respect to the maximum output power determined by the UE for an UL transmission instance in a period may not be accurately known or predicted by the gNB for periods of several seconds or more. UE power class fallback based on existing technology can then result in radio link interruption due to lower than required UL transmission power in the 5G/NR band which is undesirable. For UEs supporting 6G radio access, such scheduling coordination between the 5G/NR radio access network function and the 6G radio access network function to reduce an UL duty cycle in the FR3 6G band by the radio access network may not be possible, even in CA operation where the schedulers are independent among cells and do not communicate without delay. An UL coverage and link robustness for the UE supporting 6G radio access can then be improved.

In one embodiment the UE selects a UE power class based on a first supported UE power class associated with UL transmissions corresponding to 5G/NR radio access in a first band in FR1 and a second supported UE power class associated with UL transmissions corresponding to 6G radio access in a second band in FR3, respectively, in a band combination, to further determine a maximum output power and/or apply the corresponding transmitter power requirements according to the selected UE power class.

In a variant, the UE selects a UE power class based on a first supported UE power class associated with UL transmissions corresponding to 5G/NR radio access in a first band in FR1 and a second supported UE power class associated with UL transmissions corresponding to 6G radio access in a second band in FR1, respectively, in a band combination, to further determine a maximum output power and/or apply the corresponding transmitter power requirements according to the selected UE power class.

In a variant, the UE selects a UE power class based on a first supported UE power class associated with UL transmissions corresponding to 6G radio access in a first band in FR3 and a second supported UE power class associated with UL transmissions corresponding to 6G radio access in a second band in FR3, respectively, in a band combination, to further determine a maximum output power and/or apply the corresponding transmitter power requirements according to the selected UE power class.

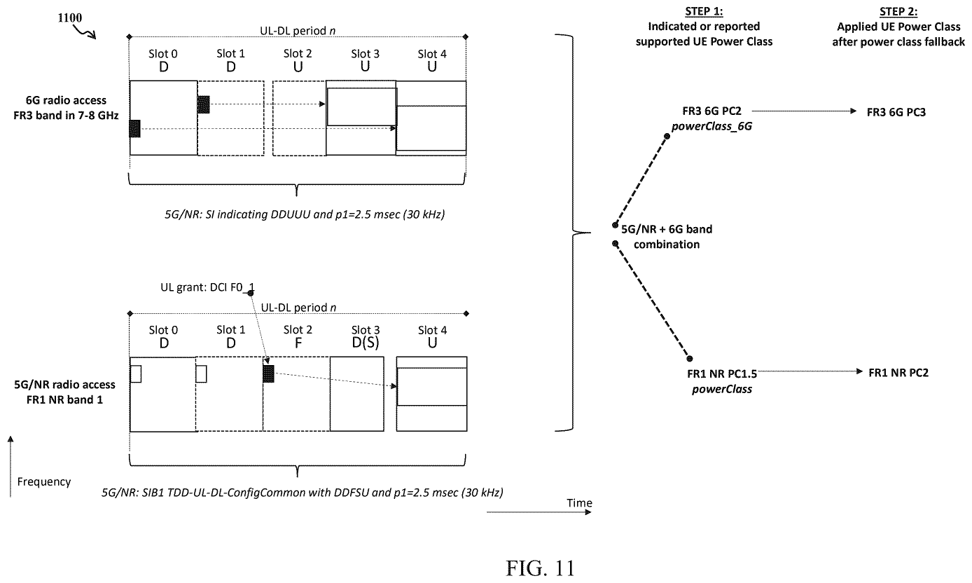

FIG. 11 illustrates an example timeline 1100 of a separate UE power class fallback behavior in a 5G/NR and 6G band combination for a wireless communication system according to embodiments of the present disclosure. The timeline 1100 of FIG. 11 can be utilized or followed by any of the UEs 111-116 of FIG. 1, such as the UE 116 of FIG. 3, and any of the BSs 111-113 of FIG. 1, such as BS 112 of FIG. 2. The timeline 1100 is for illustration only and other embodiments can be used without departing from the scope of the present disclosure.

In one example and with reference to FIG. 11, a UE supporting 6G radio access and separate power class fallback behavior indicates or reports a first supported UE power class, i.e., PC1.5, to the gNB as the power class the UE supports for UL transmissions when operating in the FR1 NR band 41 according to this band combination in UE radio access capability parameters. The UE indicates or reports a second supported UE power class, i.e., PC2 to the gNB as the power class the UE supports for UL transmissions in the FR3 6G band 7-8 GHz according to the band combination. A number of UL transmissions over a period of time may be scheduled or configured for the UE by the gNB wherein some UL transmissions may be scheduled or configured using the FR1 5G/NR band and some UL transmissions may be scheduled or configured in the FR3 6G band.

When transmitting an UL signal or channel on a carrier in the FR1 5G/NR band, the UE determines a maximum output power and/or applies the corresponding transmitter power requirements based on Class 1.5. For example, the UE may count the UL transmission with respect to a first UL duty cycle associated with UL transmissions on the carrier in the FR1 5G/NR band but does not count the UL transmission with respect to a second UL duty cycle associated with UL transmissions on the carrier in the FR3 6G band. For example, the percentage of UL symbols transmitted in a period may be determined by the UE with reference to a certain evaluation period. For example, when the percentage of UL symbols transmitted in the FR1 5G/NR carrier in a period does not exceed a threshold value provided by system specifications or by the associated maximum UL duty cycle for the supported power class, the UE determines the maximum output power and/or applies the corresponding transmitter power requirements according to Class 1.5, else when an UL duty cycle is larger than a threshold value, separate power class fallback may be applied to the FR1 5G/NR band, i.e., setting the maximum output power and/or the corresponding transmitter power requirements according to a lower than supported power class such as PC2 or the default power class PC3.

When transmitting an UL signal or channel on a carrier in the FR3 6G band, the UE determines a maximum output power and/or applies the corresponding transmitter power requirements based on power class PC2. For example, the UE may count the UL transmissions with respect to a second UL duty cycle associated with UL transmissions on the carrier in the FR3 6G band but does not count the UL transmission with respect to the first UL duty cycle associated with UL transmissions on the carrier in the FR1 5G/NR band. For example, the percentage of UL symbols transmitted in a period may be determined by the UE with reference to a certain evaluation period. For example, when the percentage of UL symbols transmitted in a period does not exceed a threshold value provided by system specifications or by the associated maximum UL duty cycle for the supported power class, the UE determines the maximum output power and/or applies the corresponding transmitter power requirements according to power class PC2, else when an UL duty cycle is larger than a threshold value, separate power class fallback may be applied to the FR3 6G band, i.e., setting the maximum output power and/or the corresponding transmitter power requirements according to a lower than supported power class such as the default power class PC3.

In one example, a UE supporting 6G radio access and separate power class fallback behavior indicates or reports a first supported UE power class, i.e., PC2, to the gNB as the power class the UE supports for UL transmissions when operating in the FR1 NR band 71 according to this band combination in UE radio access capability parameters. For the band combination, the UE separately indicates or reports a second supported UE power class, i.e., PC2 to the gNB as the power class the UE supports for UL transmissions in the FR1 6G band 4 GHz. Note that the two supported UE power classes with respect to the first and the second band in the band combination in the example may then correspond to a same power class in the indicated or reported UE power classes for the band combination. A number of UL transmissions over a period of time may be scheduled or configured for the UE by the gNB wherein some UL transmissions may be scheduled or configured using the lower FR1 5G/NR band and some UL transmissions may be scheduled or configured in the higher FR1 6G band.

When transmitting an UL signal or channel on a carrier in the lower FR1 5G/NR band, the UE determines a maximum output power and/or applies the corresponding transmitter power requirements based on PC2. For example, the UE may count the UL transmission with respect to a first UL duty cycle associated with UL transmissions on the carrier in the lower FR1 5G/NR band but does not count the UL transmission with respect to a second UL duty cycle associated with UL transmissions on the carrier in the higher FR1 6G band. For example, the percentage of UL symbols transmitted in a period may be determined by the UE with reference to a certain evaluation period. For example, when the percentage of UL symbols transmitted in the lower FR1 5G/NR carrier in a period does not exceed a threshold value provided by system specifications or by the associated maximum UL duty cycle for the supported power class, the UE determines the maximum output power and/or applies the corresponding transmitter power requirements according to power class PC2, else when an UL duty cycle is larger than a threshold value, separate power class fallback may be applied to the lower FR1 5G/NR band, i.e., setting the maximum output power and/or the corresponding transmitter power requirements according to a lower than supported power class such as the default power class PC3.

When transmitting an UL signal or channel on a carrier in the higher FR1 6G band, the UE determines a maximum output power and/or applies the corresponding transmitter power requirements based on power class PC2. For example, the UE may count the UL transmissions with respect to a second UL duty cycle associated with UL transmissions on the carrier in the higher FR1 6G band but does not count the UL transmission with respect to the first UL duty cycle associated with UL transmissions on the carrier in the lower FR1 5G/NR band. For example, the percentage of UL symbols transmitted in a period may be determined by the UE with reference to a certain evaluation period. For example, when the percentage of UL symbols transmitted in a period does not exceed a threshold value provided by system specifications or by the associated maximum UL duty cycle for the supported power class, the UE determines the maximum output power and/or applies the corresponding transmitter power requirements according to power class PC2, else when an UL duty cycle is larger than a threshold value, separate power class fallback may be applied to the higher FR3 6G band, i.e., setting the maximum output power and/or the corresponding transmitter power requirements according to a lower than supported power class such as the default power class PC3.

A first or second supported UE power class associated with UL transmissions corresponding to 5G/NR radio access in a first band and a second supported UE power class associated with UL transmissions corresponding to 6G radio access in a second band, respectively, in a band combination by the UE, can correspond to a same power class or can correspond to different power classes, wherein a band combination may comprise an FR1 band or an FR3 band or both an FR1 and an FR3 band.

When the first and the second supported UE power class in the band combination are same, a same power class fallback behavior can be applied by the UE to further determine a maximum output power and/or apply the corresponding transmitter power requirements according to the selected UE power class based on the supported UE power class associated with UL transmissions corresponding to 5G/NR radio access or 6G radio access to set an UL transmitter power.

When the first and the second supported UE power class in the band combination are same, a separate power class fallback behavior can be applied by the UE. A first selected or applied UE power class is determined by the UE based on the first supported UE power class for the first band in the band combination. A second selected or applied UE power class is determined by the UE based on the second supported UE power class for the second band in the band combination. The UE then further determines a maximum output power and/or applies the corresponding transmitter power requirements according to a selected or applied UE power class to set an UL transmitter power for UL transmissions in the first band and in the second band, respectively.

When the first and the second supported UE power class in a band combination are different, a separate power class fallback behavior can be applied by the UE. A first selected or applied UE power class is determined by the UE based on the first supported UE power class for the first band in the band combination. A second selected or applied UE power class is determined by the UE based on the second supported UE power class for the second band in the band combination. The UE then further determines a maximum output power and/or applies the corresponding transmitter power requirements according to the first and/or the second selected UE power class, respectively, to set an UL transmitter power for UL transmissions in the first band and the second band, respectively.

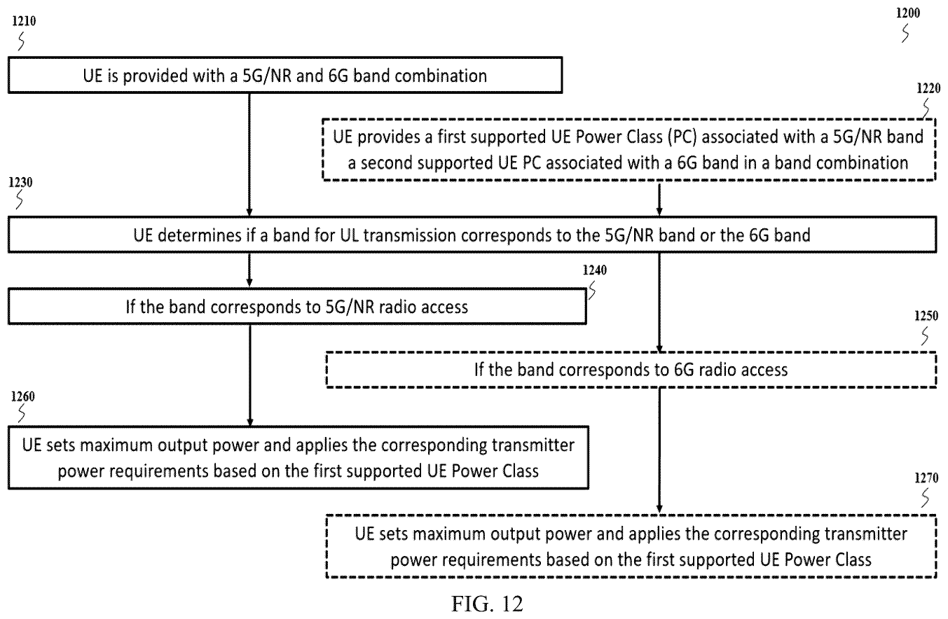

FIG. 12 illustrates an example flowchart for a process 1200 for a separate UE power class fallback behavior in a 5G/NR and 6G band combination in a wireless communication system according to embodiments of the present disclosure. The process 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1200 is for illustration only and other embodiments can be used without departing from the scope of the present disclosure.

The process 1200 begins with the UE being provided with a SG/NR and 6G band combination (1210). The UE provides a first supported UE PC associated with a 5G/NR band and a second supported UE PC associated with a 6G band in a band combination (1220). The UE determines if a band for UL transmission corresponds to the 5G/NR band or the 6G band (1230). If the band corresponds to 5G/NR radio access (1240), the UE sets maximum output power and applies the corresponding transmitter power requirements based on the first supported UE Power Class (1260). If the band corresponds to 6G radio access (1250), the UE sets maximum output power and applies the corresponding transmitter power requirements based on the first supported UE Power Class (1270).

When the first and the second supported UE power class in the band combination are same or different, a joint or common power class fallback behavior can be applied by the UE.

In one example, a first selected or applied UE power class is determined by the UE based on the first supported UE power class for the first band in the band combination. A second selected or applied UE power class is determined by the UE based on the second supported UE power class for the second band in the band combination. The UE further selects one of the first or the second selected or applied UE power classes to determine a resulting UE power class. For example, the UE may further select the resulting UE power class as the power class resulting in a lower maximum output power.

For example, when the UE determines a first selected or applied UE power class as PC3 for the FR1 5G/NR band and a second selected or applied UE power class as PC2 for the FR3 6G band, the UE further selects the lower of these PCs as resulting PC, e.g., PC3, according to a joint or common power class fallback behavior for the band combination. Based on the resulting UE power class, the UE then further determines a maximum output power and/or applies the corresponding transmitter power requirements according to the resulting UE power class to set an UL transmitter power for UL transmissions in the first band corresponding to 5G/NR radio access and the second band corresponding to 6G radio access, respectively.

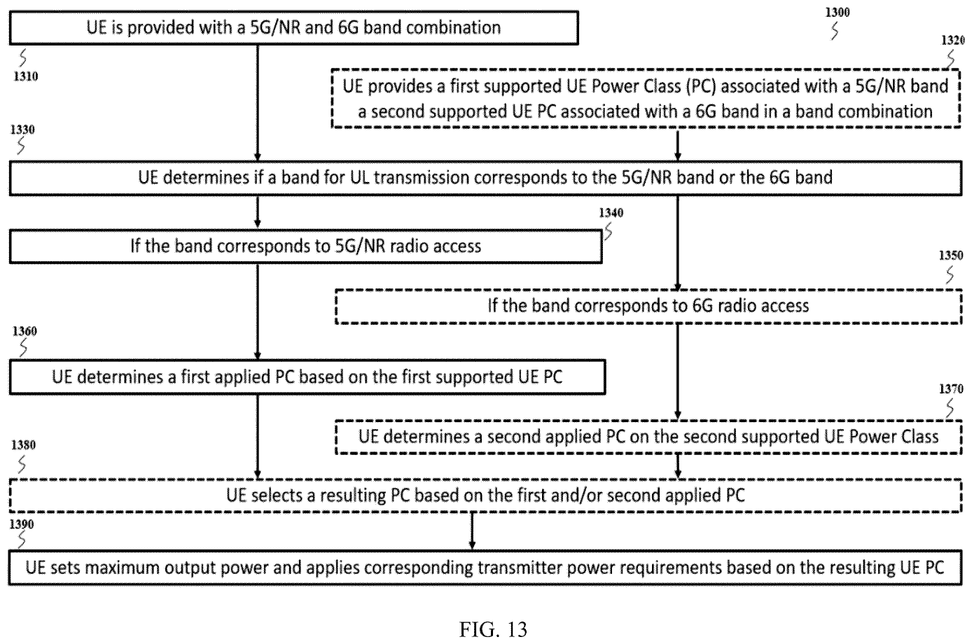

FIG. 13 illustrates an example flowchart for a process 1300 for a separate joint/common UE power class fallback behavior in a 5G/NR and 6G band combination in a wireless communication system according to embodiments of the present disclosure. The process 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1300 is for illustration only and other embodiments can be used without departing from the scope of the present disclosure.

The process 1300 begins with the UE being provided with a 5G/NR and 6G band combination (1310). The UE provides a first supported UE PC associated with a 5G/NR band and a second supported UE PC associated with a 6G band in a band combination (1320). The UE determines if a band for UL transmission corresponds to the 5G/NR band or the 6G band (1330). If the band corresponds to 5G/NR radio access (1340), the UE determines a first applied PC based on the first supported UE PC (1360). If the band corresponds to 6G radio access (1350), the UE determines a second applied PC based on the second supported UE PC (1370). The UE selects a resulting PC based on the first and/or second applied PC (1380). The UE sets maximum output power and applies corresponding transmitter power requirements based on the resulting UE PC (1390).

For the cases where a first and a second supported UE power class in the band combination are same or correspond to different power classes, and/or for cases where a same or a separate or a joint or common power class fallback behavior is applied to further determine a maximum output power, or a first and a second selected or applied UE power class; a resulting UE power class may be determined based on an UL duty cycle associated with UL transmissions in the bands, or based on a first UL duty cycle or a second UL duty cycle, respectively, wherein the first and/or the second UL duty cycle may be associated with UL transmissions on a first band and a second band, respectively.

For example, when a UE supporting 6G radio access and single UL carrier operation determines a first or a second selected or applied UE power class, or a resulting UE power class, the UE may then apply the selected or the applied or the resulting UE power class for an UL transmission corresponding to 6G radio access or to 5G/NR radio access, respectively, for an UL transmission using the first or the second UL carrier in a corresponding time-domain resource, e.g., in a slot or symbol corresponding to an UL transmission based on 6G radio access, or in a slot/symbol corresponding to an UL transmission based on 5G/NR radio access. For example, the UE may switch between UL transmissions corresponding to 6G radio access in the first carrier and to 5G/NR radio access in the second carrier, respectively.

For example, when a UE supporting 6G radio access and simultaneous UL transmission in two (or more) UL carriers in a same band or in different bands of a band combination determines a first or a second selected or applied UE power class, or a resulting UE power class, the UE may then apply the selected or the applied or the resulting UE power class for an UL transmission corresponding to 6G radio access for an UL transmission in the first UL carrier or for an UL transmission corresponding to 5G/NR radio access in the second UL carrier, respectively.

Similar considerations based on the examples can be applied to other cases such as UE power classes other than PC2 such as PC1.5 or PC1, or to other cases such as when the UE operates 5G/NR radio access and 6G radio access in a same frequency range such as within FR1, or within FR2, or within FR3, or to other cases such as when the UE operates 5G/NR radio access and 6G radio access other frequency range such as across FR1 and FR3, or across FR2 and FR3, or across FR1 and FR2, or to other cases such as when the UEs operates 4G/LTE radio access instead of 5G/NR radio access with 6G radio access.

In one embodiment the UE is provided with information by the gNB to select a UE power class based on a first supported UE power class associated with UL transmissions corresponding to 5G/NR radio access in a first band in FR1 or a second supported UE power class associated with UL transmissions corresponding to 6G radio access in a second band in FR3, respectively, in a band combination, to further determine a maximum output power and/or apply the corresponding transmitter power requirements according to the selected UE power class.

In a variant, the UE is provided with information by the gNB to select a UE power class based on a first supported UE power class associated with UL transmissions corresponding to 5G/NR radio access in a first band in FR1 or a second supported UE power class associated with UL transmissions corresponding to 6G radio access in a second band in FR1, respectively, in a band combination, to further determine a maximum output power and/or apply the corresponding transmitter power requirements according to the selected UE power class.

In a variant, the UE is provided with information by the gNB to select a UE power class based on a first supported UE power class associated with UL transmissions corresponding to 6G radio access in a first band in FR3 or a second supported UE power class associated with UL transmissions corresponding to 6G radio access in a second band in FR3, respectively, in a band combination, to further determine a maximum output power and/or apply the corresponding transmitter power requirements according to the selected UE power class.

For example, a UE power class indication for the UE may be provided or indicated to the UE by the gNB based on one of or a combination of DCI-based signaling, L1 control signaling, RRC signaling, or MAC CE signaling, or NAS based signaling, as further elaborated by the embodiments.

For example, a UE power class indication for the UE may be provided or indicated to the UE by the gNB with respect to a UE power class fallback behavior. For example, the UE power class fallback behavior (or UE power class fallback mode) may correspond to an indication received by the UE from the gNB for a desired, or a preferred, or an allowed, or a requested, or a prioritized UE power class, or can be based on a parameter provided by the gNB based on which the UE can further determine or select a UE power class for UL transmissions in a band corresponding to 5G/NR radio access or corresponding to 6G radio access in a band of a band combination, as further elaborated by the embodiments.

In one example, a UE supporting 6G radio access and separate power class fallback behavior indicates or reports a first supported UE power class, i.e., PC1.5, to the gNB as the power class the UE supports for UL transmissions when operating in the FR1 NR band 41 according to this band combination in UE radio access capability parameters. The UE indicates or reports a second supported UE power class, i.e., PC2 to the gNB as the power class the UE supports for UL transmissions in the FR3 6G band 7-8 GHz according to the band combination. A number of UL transmissions over a period of time may be scheduled or configured for the UE by the gNB wherein some UL transmissions may be scheduled or configured using the FR1 5G/NR band and some UL transmissions may be scheduled or configured in the FR3 6G band. For example, the UE or the gNB may count the UL transmission with respect to a first UL duty cycle associated with UL transmissions in the FR1 5G/NR band and/or with respect to a second UL duty cycle associated with UL transmissions in the FR3 6G band. For example, a same UL duty cycle counting may be used by the UE or by the gNB for UL transmissions in FR1 and FR3. For example, a percentage of UL symbols transmitted in a period may be determined by the UE or by the gNB with reference to a certain evaluation period. For example, the UE may indicate or report a metric representative of UL transmission levels including radio transmissions other than corresponding to 5G/NR or 6G radio access to the gNB.

When transmitting an UL signal or channel on a carrier in the FR1 5G/NR band, the UE determines a maximum output power and/or applies the corresponding transmitter power requirements based on power class PC1.5. For example, based on a percentage of transmitted UL symbols in a period in excess of a certain threshold value such corresponding to a maximum UL duty cycle associated with a supported power class, or based on the gNB reception of UL transmissions from the UE, the gNB may indicate to the UE a power class for further UL transmissions in the FR1 5G/NR band.

For example, an indicated power class for further UL transmissions from the UE in the FR1 5G/NR band may correspond to PC2. When a power class indication from the gNB is received by the UE, the UE determines a maximum output power and/or applies the corresponding transmitter power requirements for a subsequent UL transmission in the FR1 5G/NR band based on the indicated power class, i.e., the UE sets a maximum output power based on the indicated PC. For example, the UE may set a maximum output power and/or the corresponding transmitter power requirements according to a lower than supported power class such as PC2 or the default power class such as PC3 based on the power class indication which it received from the gNB.

When transmitting an UL signal or channel on a carrier in the FR3 6G band, the UE determines a maximum output power and/or applies the corresponding transmitter power requirements based on power class PC2. For example, based on a percentage of transmitted UL symbols in a period in excess of a certain threshold value such as corresponding to a maximum UL duty cycle associated with a supported power class, or based on the gNB reception of UL transmissions from the UE, the gNB may indicate to the UE a power class for further UL transmissions in the FR3 6G band. For example, an indicated power class for further UL transmissions from the UE in the FR3 6G band may correspond to PC3. When a power class indication from the gNB is received by the UE, the UE determines a maximum output power and/or applies the corresponding transmitter power requirements for a subsequent UL transmission in the FR3 6G band based on the indicated power class, i.e., the UE sets a maximum output power based on the indicated PC. For example, the UE may set a maximum output power and/or the corresponding transmitter power requirements according to an indicated or a default power class such as PC3 based on the power class indication which it received from the gNB.

In one example, a UE supporting 6G radio access and separate power class fallback behavior indicates or reports a first supported UE power class, i.e., PC2, to the gNB as the power class the UE supports for UL transmissions when operating in the FR1 NR band 71 according to this band combination in UE radio access capability parameters. The UE separately indicates or reports a second supported UE power class, i.e., PC2 to the gNB as the power class the UE supports for UL transmissions in the FR1 6G band 4 GHz according to the band combination. Note that the two supported UE power classes with respect to the first and the second band in the band combination in the example may then correspond to a same power class in the indicated or reported UE power classes for the band combination. A number of UL transmissions over a period of time may be scheduled or configured for the UE by the gNB wherein some UL transmissions may be scheduled or configured using the lower FR1 5G/NR band and some UL transmissions may be scheduled or configured in the higher FR1 6G band.

When transmitting an UL signal or channel on a carrier in the lower FR1 5G/NR band, the UE determines a maximum output power and/or applies the corresponding transmitter power requirements based on power class PC2. For example, based on a percentage of transmitted UL symbols in a period in excess of a certain threshold value such corresponding to a maximum UL duty cycle associated with a supported power class, or based on the gNB reception of UL transmissions from the UE, the gNB may indicate to the UE a power class for further UL transmissions in the lower FR1 5G/NR band.

For example, an indicated power class for further UL transmissions from the UE in the lower FR1 5G/NR band may correspond to PC2. When a power class indication from the gNB is received by the UE, the UE determines a maximum output power and/or applies the corresponding transmitter power requirements for a subsequent UL transmission in the lower FR1 5G/NR band based on the indicated power class, i.e., the UE sets a maximum output power based on the indicated PC. For example, the UE may set a maximum output power and/or the corresponding transmitter power requirements according to the supported power class or the default power class such as PC3 based on the power class indication which it received from the gNB.

When transmitting an UL signal or channel on a carrier in the higher FR1 6G band, the UE determines a maximum output power and/or applies the corresponding transmitter power requirements based on power class PC2. For example, based on a percentage of transmitted UL symbols in a period in excess of a certain threshold value such corresponding to a maximum UL duty cycle associated with a supported power class, or based on the gNB reception of UL transmissions from the UE, the gNB may indicate to the UE a power class for further UL transmissions in the higher FR1 6G band. For example, an indicated power class for further UL transmissions from the UE in the higher FR1 6G band may correspond to PC3. When a power class indication from the gNB is received by the UE, the UE determines a maximum output power and/or applies the corresponding transmitter power requirements for a subsequent UL transmission in the higher FR1 6G band based on the indicated power class, i.e., the UE sets a maximum output power based on the indicated PC. For example, the UE may set a maximum output power and/or the corresponding transmitter power requirements according to a supported power class or a default power class such as PC3 based on the power class indication which it received from the gNB.

A motivation is that support for UE power class indication from the gNB to the UE and/or a parameterization of the power class fallback or power class selection behavior by the gNB for the UE can enable the network to separately set or adjust the UL transmission behavior for the UE according to a desired, or a preferred, or a requested, or a prioritized UE power class from the network side with respect to UL transmission in the 5G/NR band and the 6G band, respectively. For example, when a maximum or a default UL duty cycle value may be exceeded for the 5G/NR band or the 6G band, respectively, in the band combination supported by the UE, a separate control and adjustment of the UE maximum output power by the network may be enabled. The gNB can indicate a higher UE maximum transmit power to the UE for a band in the band combination. This can improve the achievable UL coverage and/or the supported UL data rate in the desired band.

In one embodiment the UE is indicated by the gNB with a UE power class fallback behavior to apply for a first and a second band, respectively, in a band combination wherein the UE power class fallback behavior may correspond to a same, or a separate or a joint/common type of fallback behavior. Based on the indication from the gNB, the UE determines the UE power class fallback behavior for a later UL transmission for the first or the second band, respectively, in the band combination.

For example, the first band may correspond to 5G/NR radio access in FR1 and a second band may correspond to 6G radio access in FR3, or the first band may correspond to 5G/NR radio access in FR1 and a second band may correspond to 6G radio access in FR1, or the first band may correspond to 6G radio access in FR3 and a second band may correspond to 6G radio access in FR3. For example, the first and the second supported UE power class may correspond to a same power class or may correspond to different power classes.

In one example, when the first and the second supported UE power class are same, a same power class fallback behavior can be indicated to the UE and applied by the UE on a carrier in the first band and on a carrier in the second band of the band combination to further determine a maximum output power and/or apply the corresponding transmitter power requirements according to the selected UE power class based on the supported UE power class associated with UL transmissions in the 5G/NR band and 6G band to set an UL transmitter power.

For example, when the UE supports PC2 for the 5G/NR band and the 6G band in the band combination, the gNB may indicate to apply a same power class fallback behavior (or power class fallback mode) to the UE, e.g., use of PC3 instead, the UE then applies the indicated PC3 to set a maximum output power for a later UL transmission in the 5G/NR band or the 6G band.

In one example, when the first and the second supported UE power class are same, a separate power class fallback behavior can be indicated to the UE and applied by the UE. A first selected or applied UE power class is determined by the UE based on the first supported UE power class for the first band. A second selected or applied UE power class is determined by the UE based on the second supported UE power class for the second band. For example, the first or the second selected or applied UE power class may be indicated to the UE by the gNB. For example, the first or the second selected or applied UE power class may be determined by the UE for the indicated separate power class fallback behavior based on a first and/or second UL duty cycle or based on an adjusted UL duty cycle. The UE further determines a maximum output power and/or applies the corresponding transmitter power requirements according to a selected or applied UE power class to set an UL transmitter power for UL transmissions in the first band and the second band, respectively.

For example, when the UE supports PC2 in an FR1 5G/NR band and PC2 in an FR3 6G band of the band combination, the gNB may indicate to apply a separate power class fallback behavior (or power class fallback mode) to the UE. For example, the gNB may indicate to the UE to apply a PC3 for power class fallback in the FR1 5G/NR band but to keep applying PC2 in the FR3 6G band, respectively, for example when the UE is not coverage limited in FR1 when using PC3 and a data rate is to be maintained in FR3 by using PC2. For example, the gNB may indicate to the UE to apply a PC3 for power class fallback in the FR1 5G/NR band and also to apply PC3 for power class fallback in the FR3 6G band, respectively.

In one example, when the first and the second supported UE power class are different, a separate power class fallback behavior can be indicated to the UE and applied by the UE. A first selected or applied UE power class is determined by the UE based on the first supported UE power class for the first band in the band combination. A second selected or applied UE power class is determined by the UE based on the second supported UE power class for the second band in the band combination. For example, the first or the second selected or applied UE power class may be indicated to the UE by the gNB. For example, the first or the second selected or applied UE power class may be determined by the UE for the indicated separate power class fallback behavior based on a first and/or second UL duty cycle or based on an adjusted UL duty cycle. The UE further determines a maximum output power and/or applies the corresponding transmitter power requirements according to the first and/or the second selected UE power class, respectively, to set an UL transmitter power for UL transmissions in the first band and the second band, respectively.

For example, when the UE supports PC1.5 in the FR1 5G/NR band and PC2 in the FR3 6G band of the band combination, the gNB may indicate to apply a separate power class fallback behavior (or power class fallback mode) to the UE. For example, the gNB may indicate to the UE to keep applying a PC1.5 in the FR1 5G/NR band but to apply PC3 as power class fallback in the FR3 6G band, respectively, for example when the UE would become coverage limited in FR1 if the UE transmits with reduced maximum power. For example, the gNB may indicate to the UE to apply a PC3 for power class fallback in the FR1 5G/NR band and also to apply a PC3 for power class fallback for the FR3 6G band, respectively.

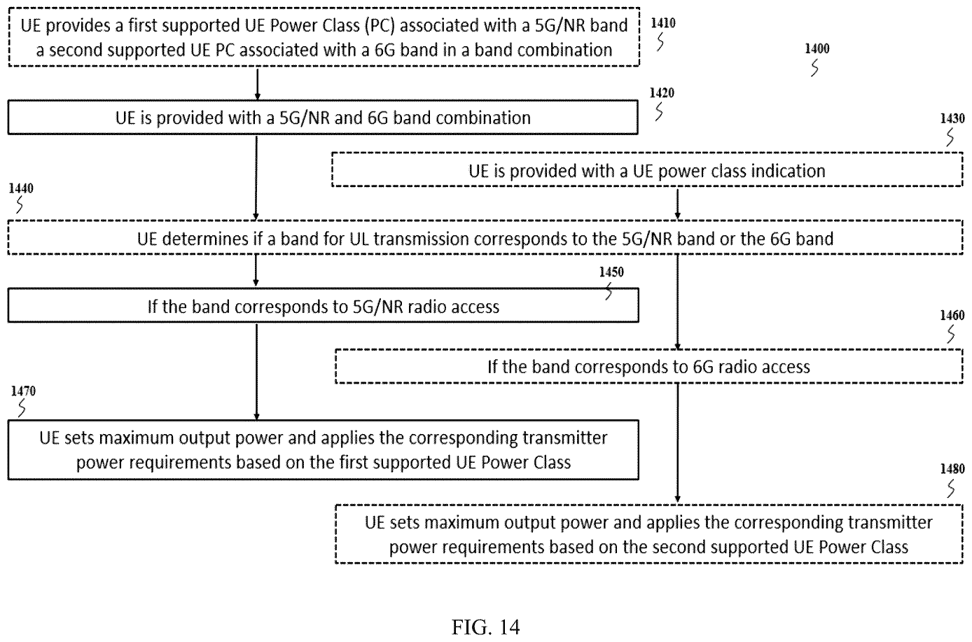

FIG. 14 illustrates an example flowchart for a process 1400 for a separate UE power class indication in a 5G/NR and 6G band combination in a wireless communication system according to embodiments of the present disclosure. The process 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1400 is for illustration only and other embodiments can be used without departing from the scope of the present disclosure.

The process 1400 begins with the UE providing a first supported UE PC associated with a 5G/NR band and a second supported UE PC associated with a 6G band in a band combination (1410). The UE is then provided with a 5G/NR and 6G band combination (1420). The UE is provided with a UE power class indication (1430). The UE determines a band for UL transmission corresponds to 5G/NR band or the 6G band (1440). If the band corresponds to SG/NR radio access (1450), the UE sets maximum output power and applies the corresponding transmitter power requirements based on the first supported UE PC (1470). If the band corresponds to 6G radio access (1460), the UE sets maximum output power and applies the corresponding transmitter power requirements based on the second supported UE PC (1480).

In one example, when the first and the second supported UE power class are same or different, a separate joint or common power class fallback behavior can be indicated to the UE and applied by the UE. For example, a first selected or applied UE power class can be determined by the UE based on the first supported UE power class for the first band of the band combination. A second selected or applied UE power class can be determined by the UE based on the second supported UE power class for the second band of the band combination. For example, the first or the second selected or applied UE power class may be indicated to the UE by the gNB. For example, the first or the second selected or applied UE power class may be determined by the UE for the indicated joint or common power class fallback behavior based on a first and/or second UL duty cycle or based on an adjusted UL duty cycle. The UE can further select one of the first or the second selected or applied UE power classes to determine a resulting UE power class. For example, the UE may further select the resulting UE power class as the power class resulting in a lower maximum output power. Based on the resulting UE power class, the UE further determines a maximum output power and/or applies the corresponding transmitter power requirements according to the resulting UE power class to set an UL transmitter power for UL transmissions in the first band and the second band, respectively.

For example, when the UE supports PC1.5 in the FR1 5G/NR band and PC2 in the FR3 6G band of a band combination, the gNB may indicate to apply a separate joint/common power class fallback behavior (or power class fallback mode) to the UE. For example, the gNB may indicate to the UE to apply a PC2 for power class fallback in the FR1 5G/NR band and to apply a PC3 for power class fallback in the FR3 6G band, respectively, for example when the UE would become coverage limited by using PC3 in FR1 such as when the UE experiences a larger path-loss towards the coverage cell in FR1 than towards the capacity cell in FR3. In another example, when the UE determines a first selected or applied UE power class as PC2 for the FR1 5G/NR band and a second selected or applied UE power class as PC3 for the FR3 6G band, the UE may further select the lower of these PCs as resulting PC, e.g., PC3, according to a joint or common power class fallback behavior (or power class fallback mode) for the bands in the band combination.

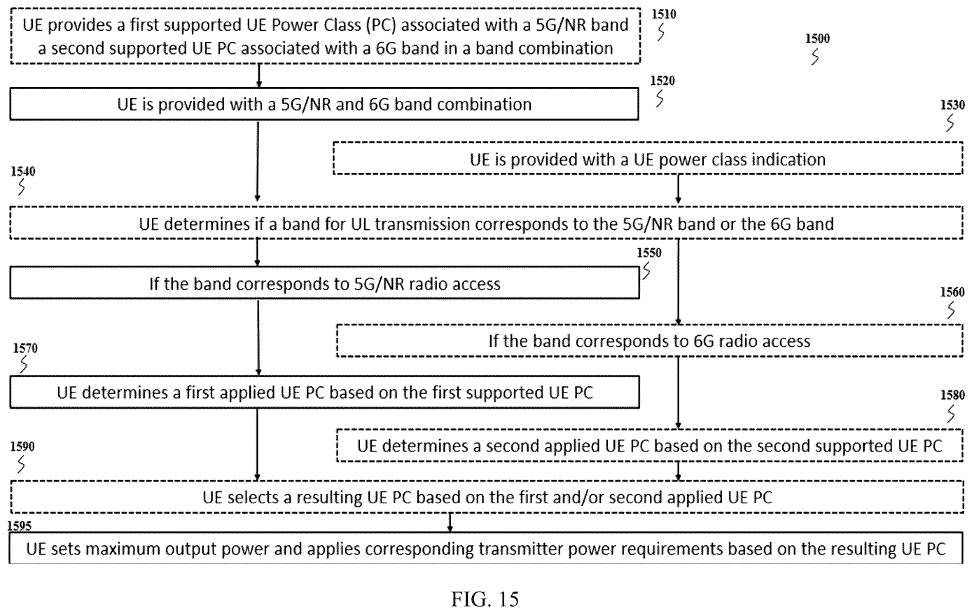

FIG. 15 illustrates an example flowchart for a process 1500 for a separate joint/common UE power class indication in a 5G/NR and 6G band combination in a wireless communication system according to embodiments of the present disclosure. The process 1500 of FIG. 15 can be performed by any of the UEs 111-116 of FIG. 1, such as the UE 116 of FIG. 3, and a corresponding method can be performed by any of the BSs 101-103 of FIG. 1, such as BS 102 of FIG. 2. The process 1500 is for illustration only and other embodiments can be used without departing from the scope of the present disclosure.

The process 1500 begins with the UE providing a first supported UE PC associated with a 5G/NR band and a second supported UE PC associated with a 6G band in a band combination (1510). The UE is provided with a 5G/NR and 6G band combination (1520). The UE is provided with a UE power class indication (1530). The UE determines if a band for UL transmission corresponds to the 5G/NR band or the 6G band (1540). If the band corresponds to 5G/NR radio access (1550), the UE determines a first applied UE PC based on the first supported UE PC (1570). If the band corresponds to 6G radio access (1560), the UE determines a second applied UE PC based on the second supported UE PC (1580). The UE selects a resulting UE PC based on the first and/or second applied UE PC (1590). The UE sets maximum output power and applies corresponding transmitter power requirements based on the resulting UE PC (1595).

Similar considerations based on the examples can be applied to other cases such as UE power classes other than PC2 such as PC1.5 or PC1, or to other cases such as when the UE operates 5G/NR radio access and 6G radio access in a same frequency range such as within FR1, or within FR2, or within FR3, or to other cases such as when the UE operates 5G/NR radio access and 6G radio access other frequency range such as across FR1 and FR3, or across FR2 and FR3, or across FR1 and FR2, or to other cases such as when the UEs operates 4G/LTE radio access instead of 5G/NR radio access with 6G radio access.

In one embodiment the UE is indicated by the gNB with a UE power class fallback behavior to apply for a first or a second band, respectively, in a band combination wherein the UE power class fallback behavior corresponds to a desired, or a preferred, or an allowed, or an enabled, or a requested, or a prioritized UE power class. Based on the indication from the gNB, the UE determines the UE power class fallback behavior for a later UL transmission for the first band or the second band, respectively, in the band combination.

In a variant, the UE power class fallback behavior to apply for a first or a second band, respectively, in a band combination, may correspond to a sequence or a list providing a preference or order of carriers or bands according to which a UE power class fallback may be applied first or last in the band combination.

For example, the UE power class fallback behavior may correspond to an indication received by the UE from the gNB for a desired, or a preferred, or an allowed, or an enabled, or a requested, or a prioritized UE power class associated with a carrier or a band in a band combination. For example, a UE power class fallback behavior may correspond to an indication received by the UE from the gNB for a not desired, or a not preferred, or a disallowed, or a disabled UE power class. More than one desired, or preferred, or allowed, or enabled, or requested, or prioritized or more than one not desired, or not preferred, or disallowed, or disabled UE power classes may be indicated to the UE, i.e., indicated as a set. When a set is indicated, and more than one UE power class can be selected by the UE, a suitable rule can be defined to determine a UE power class from the set. For example, the UE may select the first UE power class in a list or in a set, or the UE power class resulting in highest or a lowest maximum output power, etc.

In one example, when the UE receives a UE power class indication from the gNB wherein the UE power class fallback behavior corresponds to a requested UE power class, the UE applies the indicated UE power class for a later UL transmission in the corresponding band on a carrier to further determine a maximum output power and/or applies the corresponding transmitter power requirements according to the requested UE power class.

For example, when the UE applies PC2 to an FR1 5G/NR band and the UE receives a UE power class indication corresponding to a requested PC3 for the FR1 5G/NR band, the UE then applies the requested power class for a maximum output power of a later UL transmissions in the FR1 5G/NR band but does not apply the requested PC3 to the FR3 6G band.

For example, the UE may be indicated by the gNB with a UE power class fallback behavior to apply on a carrier in a band of the band combination wherein the UE power class fallback behavior corresponds to a provided set of time-domain resources, i.e., a set of slots/symbols on the carrier or in the band. Based on the indication from the gNB, the UE determines the UE power class fallback behavior for a later UL transmission in the set of slots/symbols, respectively, on the carrier or in the band.

For example, a set of slots/symbols associated with a UE power class fallback behavior or with a UE power class may be provided to the UE by higher layers. For example, a DCI-based indication may be used to provide the UE with information for the set of slots/symbols associated with a UE power class fallback behavior or with a UE power class. For example, the set of slots/symbols associated with a UE power class fallback behavior or a UE power class may be tabulated and/or listed by system operating specifications. One or a combination of these methods may be used. For example, a UE power class fallback behavior or a UE power class may be associated with an UL signal or channel type such as corresponding to UL transmissions of a PUCCH, PUSCH, SRS or PRACH by the UE. For example, a first and a second set of slots/symbols on a serving cell associated with a UE power class indication may be configured or indicated to the UE, respectively. For example, a set of symbols/slots or a set of symbol/slot identifiers associated with a set of slots/symbols may correspond to a bitmap or a list of slots/symbols or a SLIV value with a start and run length number of slots/symbols. For example, a set of symbols/slots may be provided to the UE as a type ‘valid’ or “invalid” with respect to an allowed or a disallowed UE power class behavior in a symbol/slot. For example, a set of symbols/slots may be provided to the UE as an assumed or as an indicated reference serving cell UL/DL configuration with respect to 4G/LTE radio access, or as an assumed or as an indicated reference UL/DL configuration with respect to 5G/NR radio access such as provided in an assumed or indicated tdd-UL-DL-ConfigurationCommon or tdd-UL-DL-ConfigurationDedicated including a set of symbol types ‘D, or ‘U, or ‘F’. For example, a set of symbol/slot identifiers associated with a set of slots/symbols may be indicated to the UE by DCI or provided to the UE by higher layer signaling such as RRC or by MAC CE.

In one example, when the UE receives a UE power class indication from the gNB wherein the UE power class fallback behavior corresponds to a prioritized list or a set of carriers or bands, the UE selects a UE power class from the list or the set. For example, the UE may select a highest priority carrier or band in the band combination, and the UE applies the selected UE power class for a later UL transmission in the corresponding carrier or band of the band combination to further determine a maximum output power and/or apply the corresponding transmitter power requirements according to the prioritized list or the set of UE power classes.

For example, a UE may apply PC1.5 for UL transmissions in an FR1 5G/NR band and PC2 for UL transmissions in the FR3 6G band. The UE may be provided with information by the gNB wherein the UE power class fallback behavior corresponds to a prioritized list of bands wherein the FR3 6G band is set to high priority and the FR1 5G/NR band is set to low priority. Under conditions where power class fallback is needed by the UE, the UE then first selects the higher priority band, i.e., FR3 6G, to preserve the maximum output power level for this band in the band combination and first applies power class fallback to the lower priority FR1 5G/NR band to meet applicable regulatory requirements. For example, the UE may first apply PC2 or PC3 to UL transmissions in the FR1 5G/NR band but maintain PC2 in the FR3 6G band. If an additional power reduction for UL transmissions in the band combination is needed, the UE then may apply a second power class fallback to UL transmissions in the FR3 6G band. For example, the UE may then apply PC3 as fallback power class in the FR3 6G band after it first applied power class fallback to the FR1 5G/NR band. The reverse can also apply where the UE is indicated the FR3 6G band as low priority and the FR1 5G/NR band as high priority. For example, the gNB can determine the band to set as high priority based on a coverage condition by the UE in FR1, for example as determined by an associated RSRP report or a power-headroom report, by the UE. For example, when the UE would not become coverage limited when the FR1 5G/NR band is low priority for power class fallback, the gNB can indicate the FR1 5G/NR band as low priority for power class fallback; otherwise, the gNB can indicate the FR3 6G band as low priority for power class fallback (and indicate the FR1 5G/NR band as high priority for power class fallback).

As can be seen by someone skilled in the art, similar considerations can be applied to other cases such as when multiple priority levels associated with a default, a fallback or a supported UE power class are used, or to other cases such as when a high, or a medium or a low priority levels are used, or to other cases such as when a priority is provided from a value range, e.g., 1 corresponding to highest priority and 5 corresponding to a lowest priority, or equivalent.

In one example, the UE is indicated by the gNB with a slot/symbol type in a band of a band combination on which to first apply a UE power class fallback in the band. In one example, the UE may be indicated a slot/symbol type on which a UE power class fallback should be last applied in the band. In one example, the UE may be indicated a priority level corresponding to a slot/symbol type based on which the UE determines a first type of slots/symbols to apply a UE power class fallback, and/or a last type of slots/symbols to apply a UE power class fallback on a carrier in a band of the band combination.

For example, the UE may be provided with a list or order in which to apply a UE power class fallback from the gNB wherein a slot/symbol type ‘U’ may correspond to ‘last’ or ‘not preferred”, and a slot/symbol type ‘F’ may correspond to ‘preferred’. When a UE power class fallback is indicated or applied by the UE, for example to meet an MPE requirement, the UE first applies UE power class fallback corresponding to UL transmissions in ‘F’ slots/symbols on the carrier in the band of the band combination, and when not sufficient, then to UL transmissions in ‘U’ slots/symbols on the carrier.

In one embodiment the UE is indicated by the gNB with a UE power class fallback behavior to apply for a first or a second band in a band combination based on a condition wherein at least one band is indicated for 6G radio access.

For example, a UE power class fallback behavior or a UE power class may be provided, configured or indicated to the UE with respect to one of or a combination of the following conditions:
A symbol or slot type, e.g., a symbol/slot type ‘D’ or ‘F’ or ‘U’; or a symbol/slot of type subband full duplex (SBFD), or of type ‘non-SBFD’, or ‘valid’ or ‘invalid’
A transmission or allocation bandwidth corresponding to a carrier or an UL signal or UL channel
A TRP or TRPs, e.g., TRP A and/or TRP B, or a CORESETPoolIndex associated with CORESETs for PDCCH receptions, or a TRP identified by one or more SS/PBCH blocks (SSBs).
A number of symbol or slots, e.g., number of consecutive symbols or slots, or number of symbols or slots in a period.
A set of symbol/slot identifiers, e.g., a bitmap, or a list of symbols/slots, or a resource indicator value such as SLIV with starting slot/symbol value and a run length value in an index representation.
An UL signal or channel type, e.g., PUCCH, PUSCH, PRACH or SRS.
A transmission format of an UL signal or UL channel such as PUSCH, or PUCCH, or PRACH, or SRS

In one example, a condition associated with a UE power class fallback behavior may correspond to a minimum number TH for the number of RBs S of a PUSCH allocation on a symbol in a slot in a band of the band combination. The UE applies UE power class fallback to an UL transmission in the slot in the band when the number S of RBs which is indicated or provided to the UE for the PUSCH allocation on a symbol in the slot is equal to or larger than the minimum number TH; otherwise, the UE does not apply UE power class fallback to the UL transmission in the slot.

In one example, a condition associated with a UE power class fallback behavior may correspond to a maximum number TH for the number of RBs S of a PUSCH allocation on a symbol in a slot in a band of the band combination. The UE applies UE power class fallback to an UL transmission in the slot in the band when the number S of RBs which is indicated or provided to the UE for the PUSCH allocation on a symbol in the slot is less than a maximum number TH; otherwise, the UE does not apply UE power class fallback to the UL transmission in the slot.

In one example, a condition associated with a UE power class fallback behavior may correspond to a transmission format of an UL signal or UL channel in a band of the band combination. For example, a transmission format with respect to PUSCH may correspond to one or a combination of the following, an RB allocation, a symbol allocation, a modulation scheme, a modulation order, an MCS, a TBS, a channel coding type or rate, a payload type such as data or UCI/control, a UCI/control payload type such as A/N, or CSI, or CSI part 1, or CSI part 2, or a UCI/control reporting type such as periodic, or semi-persistent, or aperiodic CSI report in the control payload.

For example, a condition or a restriction may correspond to a minimum MCS level TH for the PUSCH transmission in a slot. The UE applies UE power class fallback to the PUSCH transmission in the band when the MCS for the PUSCH transmission in the band is equal to or larger than the minimum UL MCS level TH, otherwise the UE does not apply the UE power class fallback to the PUSCH transmission in the band.

For example, a condition or a restriction may correspond to a maximum MCS level TH for the PUSCH transmission in a slot. The UE applies UE power class fallback to the PUSCH transmission in the band when the MCS for the PUSCH transmission in the band is larger than the maximum UL MCS level TH, otherwise the UE does not apply the UE power class fallback to the PUSCH transmission in the band.

For example, a condition or a restriction may correspond to UCI/control payload type for the PUSCH transmission in a band. The UE applies UE power class fallback to the PUSCH transmission in the band when the UCI/control payload type is CSI or CSI part 1 or CSI part 2 for the PUSCH transmission in the slot, otherwise, e.g., when the UCI/payload type is HARQ-ACK information, the UE does not apply UE power class fallback to the PUSCH transmission in the band.

In one embodiment the UE is indicated by the gNB with a UE power class fallback behavior to apply for a first or a second band in a band combination for a duration; wherein at least one band is indicated for 6G radio access. Based on the indication from the gNB, the UE determines a start timing and/or and end timing for the duration to apply a UE power class fallback behavior for an UL transmission in a band of the band combination.

In one example, a UE power class fallback behavior may be associated with duration T during which a UE power class fallback behavior for UL transmission in a band of a band combination is applied but is not applied earlier than a start timing or later than an end timing based on the duration T. The UE applies the UE power class fallback behavior to UL transmission in the band when the UL transmission occurs during the duration T. A suitably selected reference timing may be chosen. For example, a duration T corresponding to UL transmissions when UE power class fallback should be applied after receiving a UE power class fallback indication may correspond to a timing of TH msec or of TH symbols/slots/subframes.

For example, a duration associated with a UE power class fallback behavior or with a UE power class may be provided to the UE by higher layers. For example, a DCI-based indication may be used to provide the UE with a duration associated with a UE power class fallback behavior or with a UE power class. For example, a duration associated with a UE power class fallback behavior or a fallback UE power class may be tabulated and/or listed by system operating specifications.

In one embodiment the UE is indicated by the gNB with a UE power class fallback behavior to apply for a first or a second band in a band combination with respect to an activation timing; wherein at least one band is indicated for 6G radio access. Based on the indication from the gNB, the UE determines a start timing and/or and end timing for the duration to apply a UE power class fallback behavior for an UL transmission in a band of the band combination.

In one example, a UE power class fallback behavior may be associated with an activation timing TH to apply a UE power class fallback behavior for UL transmission in a band of a band combination. The UE applies the UE power class fallback behavior to UL transmission in the band with respect to a suitably selected reference timing. For example, a first UL transmission in which to apply a UE power class in the band after receiving a UE power class indication may correspond to a timing of TH msec or TH symbols with respect to reception of a PUSCH or a symbol of a PDCCH in which the indication was received by the UE.

For example, an activation timing associated with a UE power class fallback behavior or with a UE power class may be provided to the UE by higher layers. For example, a DCI-based indication may be used to provide the UE with an activation timing associated with a UE power class fallback behavior or with a UE power class. For example, an activation timing associated with a UE power class fallback behavior or a UE power class may be tabulated and/or listed by system operating specifications.

In one embodiment, a UE power class indication may be provided for or indicated to the UE by the gNB based on one of or a combination of DCI-based signaling, L1 control signaling, RRC signaling, or MAC CE based signaling.

For example, a UE power class fallback behavior or a UE power class may be provided, configured or indicated to the UE based on one of or a combination of DCI-based signaling, or L1 control signaling, or RRC signaling, or MAC CE based signaling, or NAS based signaling. Based on the UE power class fallback indication, the UE can determine a UE power class fallback behavior and/or the UE can determine or select a UE power class for a band in a band combination. Using the UE power class fallback behavior or the determined or selected UE power class, the UE can further determine a maximum output power and/or apply the corresponding transmitter power requirements according to the determined or selected UE power class for UL transmissions in the band of the band combination.

For example, a configuration associated with a UE power class fallback behavior or with a UE power class may be provided to the UE by higher layers. For example, a DCI-based indication may be used to provide the UE with information associated with a UE power class fallback behavior or with a UE power class. For example, a UE power class fallback behavior or a UE power class may be tabulated and/or listed by system operating specifications. A configuration for a UE power class fallback behavior or for a UE power class may be provided by higher layers to the UE and used in conjunction with DCI-based indication by the UE to determine a UE power class fallback behavior or to determine or select a UE power class. If a same UE power class fallback behavior or a same UE power class can be provided for multiple UEs, a common DCI or common RRC signaling message may be used. A UE-specific DCI or RRC signaling of dedicated or common type may be used to provide information associated with a UE power class fallback behavior or with a UE power class to a UE. A value or a set of values may be associated with a parameter for a UE power class fallback behavior or with a UE power class. For example, a UE may select or determine a value from the set of values associated with a UE power class fallback behavior or with a UE power class based on an index value indicated through a DCI format or through MAC-CE signaling wherein the UE may select from one or more entries provided in an RRC configurable table associated with an index value. The UE may determine a default condition or a default value associated with a UE power class fallback behavior or with a UE power class.

In one example, a UE power class fallback behavior or a UE power class is provided to the UE using higher layer signaling. For example, a UE may be provided with a configuration of a UE power class fallback behavior or a UE power class based on a higher layer parameter such as ServingCellConfig or PUSCH-Config.

In one example, a PUSCH time-domain resource allocation (TDRA) table may be configured for the UE by higher layers and include a parameter associated with a UE power class fallback behavior or a UE power class. For example, the PUSCH time-domain resource allocation table may be configured for the UE by higher layers and include a parameter associated with a UE power class fallback behavior or a UE power class, e.g., for a row of the PUSCH TDRA table or as a parameter provided in the configuration for the PUSCH TDRA table. For example, the UE may be indicated an entry of the PUSCH TDRA table associated with a UE power class fallback behavior or a UE power class using a TDRA field in a DCI format. For example, a PUSCH TDRA table associated with a UE power class fallback behavior or a UE power class corresponding to an UL transmission may be used based on a configured grant. The UE determines a power for the PUSCH transmission based on the indicated power class.

In one example, a power control configuration may be provided to the UE by higher layers or tabulated by system operating specifications and include a parameter associated with a UE power class fallback behavior or a UE power class. For example, the power control configuration may include a closed loop TPC adjustment value such as +1 dB or −3 dB and include a parameter associated with a UE power class fallback behavior or a UE power class such as supported UE power class or default UE power class. For example, the UE may be indicated an entry of the power control configuration associated with a UE power class fallback behavior or a UE power class using a TPC command for scheduled PUSCH field in a DCI format or using a dedicated field in the DCI format.

In one example, information may be provided to the UE by higher layers to associate a DL or UL reference signal or a DL or an UL or joint TCI state(s) or RS resource index(es) such as corresponding to an SSB or to a CSI-RS resource index with a UE power class fallback behavior or a UE power class for an UL transmission. For example, a first TCI state may correspond to an UL transmission for a first UE power class fallback behavior or a first UE power class in a first band, and a second TCI state may correspond to an UL transmission for a second UE power class fallback behavior or a second UE power class in a second band, wherein the first and second bands can be same or different. For example, a PUSCH transmission scheduled by a DCI format in a PDCCH can be associated a first UE power class fallback behavior or a first UE power class in a first band when the PDCCH is received in a CORESET with a first value for CORESETPoolIndex, and be associated a second UE power class fallback behavior or a second UE power class in a second band when the PDCCH is received in a CORESET with a second value for CORESETPoolIndex, wherein the first and second bands can be same or different.

Similar considerations can be applied to other cases such as when a UE power class fallback behavior or a UE power class is provided to the UE using CN based signaling or to other cases such as when a UE power class fallback behavior or a UE power class may be provided, e.g., stored or provisioned for the UE based on a USIM/UICC and related protocol signaling.

For example, the UE may indicate or report to the gNB a supported UE power class fallback behavior or a UE power class for a band using 6G radio access in a band combination using higher layer signaling such as an RRC UECapabilityInformation message. For example, the UE may indicate or report to the gNB a supported UE power class fallback behavior or a UE power class associated with operation in an FR3 6G band or band combination in UE radio access capability information. For example, a gNB may initiate a procedure using a UECapabilityEnquiry message.

In one example, the UE indicates or reports to the gNB a supported UE power class fallback behavior for the bands in a band combination in a UE radio access capability information wherein the UE power class fallback behavior may correspond to a same, or a separate, or a joint or common type of fallback behavior for the bands in the band combination; and wherein one or more bands may use 6G radio access.

In one example, the UE indicates or reports to the gNB a duration or a value for activation timing associated with a UE power class fallback behavior for the bands in a band combination wherein one or more bands may use 6G radio access.

In one example, the UE indicates or reports to the gNB a supported UE power class fallback behavior for a first or a second band in the band combination in a UE radio access capability information wherein the UE power class fallback behavior corresponds to an ordering or a sequence of carriers or bands corresponding to which the UE may apply a UE power class fallback, e.g., indicative of a carrier or a band in the band combination on which a UE power class fallback may be applied first or last by the UE; wherein one or more bands may use 6G radio access.

For example, the UE may indicate to the gNB a desired, a preferred, or a priority-based UE power class fallback behavior or a UE power class for a band using 6G radio access in a band combination using higher layer signaling such as a higher layer RRC UEAssistanceInformation message, wherein one or more bands may use 6G radio access.

In one example, the UE indicates to the gNB a desired or a preferred UE power class fallback behavior for a first and/or a second band in a band combination including a band using 6G radio access wherein the UE power class fallback behavior may correspond to a same, or a separate, or a joint or common type of fallback behavior.

In one example, the UE indicates to the gNB a desired or a preferred UE power class fallback behavior for a first or a second band in the band combination in a UE radio access capability information wherein the UE power class fallback behavior corresponds to an ordering or a sequence of carriers or bands corresponding to which the UE may apply a UE power class fallback, e.g., indicative of a carrier or a band in the band combination on which a UE power class fallback may be applied first or last by the UE; wherein one or more bands may use 6G radio access.

In one example, the UE indicates to the gNB a value for a first UL duty cycle associated with UL transmissions in a first 5G/NR band and a value for a second UL duty cycle associated with a second 6G band, respectively, wherein the first or the second band may correspond to an FR1 band or an FR3 band.

In one embodiment the UE provides a serving gNB with information using a Power Headroom reporting procedure or a Power Headroom Report (PHR) to indicate information associated with a UE power class fallback behavior or a UE power class for a first or for a second band, respectively, in a band combination to the gNB.

For example, a PHR associated with a UE power class fallback behavior or a UE power class in a band or for the band combination may be triggered, i.e., by an event such as change of a UE power class or a change of the UE power class fallback behavior, or may be reported according to a timer value. For example, the UE may indicate to the gNB a change of an applied or a selected or a resulting UE power class in a band or in a band combination in a PHR. For example, the UE may indicate to the gNB an assumed or a selected or a reference UE power class fallback behavior (or UE power class fallback mode) in a PHR wherein a UE power class fallback behavior may correspond to a same, or a separate, or a joint/common type of fallback behavior. For example, the UE may indicate to the gNB an applied or a selected or a resulting UE power class in a band or in a band combination in a PHR according to a provided reporting time interval for the PHR such as based on a parameter

phr-Periodic Timer

For example, a PHR associated with a UE power class fallback behavior or a UE power class for a band or a band combination may correspond to a Type 1, or a Type 2, or a Type 3 PHR. In one example, using a Type 1 PHR, the UE may indicate the difference between the nominal UE maximum transmit power and the estimated power for an UL-SCH transmission per activated Serving Cell corresponding to an applied or a selected or a resulting UE power class. In one example, using a Type 2 PHR, the UE may indicate the difference between a nominal UE maximum transmit power and the estimated power for an UL-SCH or PUCCH transmission on SpCell of the other MAC entity, i.e., a 4G/LTE MAC entity or a 5G/NR MAC entity, corresponding to an applied or a selected or a resulting UE power class. In one example, using a Type 3 PHR, the UE may indicate the difference between the nominal UE maximum transmit power and the estimated power for SRS transmission corresponding to an applied or a selected or a resulting UE power class. For example, information corresponding to an applied or a selected or a resulting UE power class or a UE power class fallback behavior may be included in a PHR based on a field or a value of a field in the PHR. For example, one or multiple PHR values/fields corresponding to a UE power class fallback behavior or a UE power class may be included in a PHR report from the UE. For example, a PHR format may correspond to a combination of one or more MAC CE field(s), PHR reporting mode(s), associated timer value(s), or a PHR configuration. For example, a PHR with respect to a first band and a second band, respectively, in a band combination may be separately parameterized. In one example, a first PHR format may be provided for an actual or reference PUSCH or an SRS transmission in a first band of a band combination using a first associated timer value such as phr-PeriodicTimer=‘sf100’, and a second PHR format may be provided for an actual or reference PUSCH or an SRS transmission in a second band of the band combination using a same value or another value for an associated reporting timer such as phr-Periodic Timer=‘sf20’.

For example, the UE can be provided by higher layers with information to enable or disable PHR for an actual PUSCH transmission, or for a transmission based on a reference PUSCH format with respect to the first band, or with respect to the second band, or with respect to any band, or for none of the bands in a band combination. The UE may then determine a band in the band combination for which PHR is reported.

For example, the UE can be provided information that PHR of an actual or a reference PUSCH transmission or an SRS transmission is disabled for a carrier in a band corresponding to 5G/NR radio access but enabled for a carrier in a band corresponding to 6G radio access in a band combination. For example, the UE can be provided information that PHR of an actual or a reference PUSCH transmission or an SRS transmission is enabled for a carrier in the band corresponding to 5G/NR radio access and for a carrier in the band corresponding to 6G radio access in a band combination.

For example, a PHR corresponding to UE power class fallback behavior or a UE power class from the UE may be triggered when one or more of the following events occur: a phr-ProhibitTimer expires or has expired and the path loss has changed more than phr-Tx-PowerFactorChange dB for at least one activated Serving Cell; a phr-PeriodicTimer expires; upon configuration or reconfiguration of the power headroom reporting functionality by upper layers, which is not used to disable the function; a phr-ProhibitTimer expires or has expired when the MAC entity has UL resources for new transmission; and power headroom reporting on the UL resource is enabled by higher layers.

For example, the UE may determine a first PHR format PHR1 for an actual or a reference PUSCH transmission or a second PHR format PHR2 for an actual or a reference PUSCH transmission on a serving cell on a carrier in the first band and on a carrier in the second band, respectively, of the band combination. The first PHR format PHR1 for an actual or a reference PUSCH transmission for a serving cell may be associated with PUSCH transmissions by the UE in a carrier corresponding to 5G/NR radio access. The second PHR format PHR2 for an actual or a reference PUSCH transmission on a serving cell may be associated with PUSCH transmissions by the UE in a carrier corresponding to 6G radio access. The UE may use a PHR format to provide PHR for actual or reference PUSCH transmission(s) in one or multiple slots of a carrier where the PHR format may include PHR value(s) and an associated UE power class behavior or UE power class.

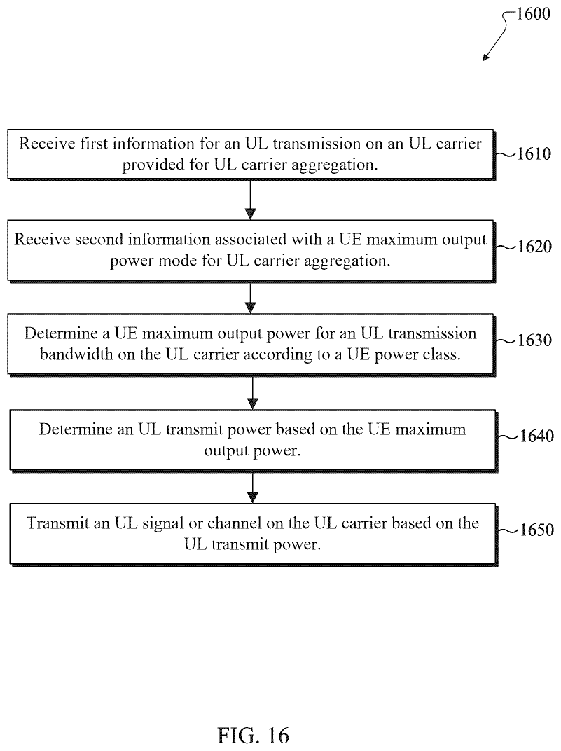

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE receiving first information for an UL transmission on an UL carrier provided for UL carrier aggregation (1610). The UE then receives second information associated with a UE maximum output power mode for UL carrier aggregation (1620).

The UE then determines a UE maximum output power for an UL transmission bandwidth on the UL carrier according to a UE power class (1630). For example, in 1630, the UE determines the UE maximum output power based on the first and the second information. In various embodiments, the UL carrier is a first UL carrier, and a second UL carrier is provided for carrier aggregation. The UE maximum output power associated with the first and second UL carriers corresponds to at least one of a same determined UE maximum output power for UL transmissions in the first and second UL carriers, a separately determined UE maximum output power for UL transmissions in the first UL carrier and the second UL carrier, and a jointly determined UE maximum output power for a first UL transmission in the first UL carrier and a second UL transmission in the second UL carrier in a same time-domain resource.

In various embodiments, the UE determines the UE maximum output power mode according to a band combination or a frequency range combination for the first and second UL carriers. In various embodiments, the UE determines the UE maximum output power mode for UL carrier aggregation based on the UE maximum output power for the first UL carrier when a simultaneous UL transmission using the first and second UL carriers in a same time-domain resource is not indicated. The UE determines the UE maximum output power mode for UL carrier aggregation based on a first UE maximum output power associated with the first UL carrier and a second UE maximum output power associated with the second UL carrier when a simultaneous UL transmission using the first and second UL carriers in a same time-domain resource is indicated.

The UE then determines an UL transmit power based on the UE maximum output power (1640). In various embodiments, the UE receives an indication corresponding to the UE maximum output power mode for UL carrier aggregation and determines the UL transmit power based on the indication. The UE then transmits an UL signal or channel on the UL carrier based on the UL transmit power (1650). In various embodiments, the UE transmits, via UCI, a MAC CE, or a RRC message, values for first and second supported or indicated UE maximum output powers corresponding to the first and second UL carriers, respectively, or a value for a supported or indicated UE maximum output power mode corresponding to the first and second UL carriers.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for operating a user equipment (UE), the method comprising:
receiving first information for an uplink (UL) transmission on an UL carrier provided for UL carrier aggregation;
receiving second information associated with a UE maximum output power mode for UL carrier aggregation;
determining, based on the first and the second information, a UE maximum output power for an UL transmission bandwidth on the UL carrier according to a UE power class;
determining an UL transmit power based on the UE maximum output power; and
transmitting, based on the UL transmit power, an UL signal or channel on the UL carrier.

2. The method of claim 1, wherein:
the UL carrier is a first UL carrier,
a second UL carrier is provided for carrier aggregation, and
the UE maximum output power associated with the first and second UL carriers corresponds to at least one of:
a same determined UE maximum output power for UL transmissions in the first and second UL carriers,
a separately determined UE maximum output power for UL transmissions in the first UL carrier and the second UL carrier, and
a jointly determined UE maximum output power for a first UL transmission in the first UL carrier and a second UL transmission in the second UL carrier in a same time-domain resource.

3. The method of claim 1, wherein:
the UL carrier is a first UL carrier,
a second UL carrier is provided for carrier aggregation, and
the method further comprises determining the UE maximum output power mode according to the UE power class on a band combination or a frequency range combination for the first and second UL carriers.

4. The method of claim 1, wherein
receiving the second information associated with the UE maximum output power mode further comprises receiving an indication corresponding to the UE maximum output power mode, and
determining the UL transmit power based on the UE maximum output power further comprises determining the UL transmit power based on the indication.

5. The method of claim 1, wherein:
the UL carrier is a first UL carrier,
a second UL carrier is provided for carrier aggregation, and
the method further comprises transmitting, via uplink control information (UCI), a medium-access-control (MAC) control element (CE), or a radio resource control (RRC) message, (i) values for first and second supported or indicated UE maximum output powers corresponding to the first and second UL carriers, respectively, or (ii) a value for a supported or indicated UE maximum output power mode corresponding to the first and second UL carriers.

6. The method of claim 1, wherein:
the UL carrier is a first UL carrier,
a second UL carrier is provided for carrier aggregation, and
the method further comprises:
determining the UE maximum output power mode for UL carrier aggregation based on the UE maximum output power for the first UL carrier when a simultaneous UL transmission using the first and second UL carriers in a same time-domain resource is not indicated; and
determining the UE maximum output power mode for UL carrier aggregation based on a first UE maximum output power associated with the first UL carrier and a second UE maximum output power associated with the second UL carrier when a simultaneous UL transmission using the first and second UL carriers in a same time-domain resource is indicated.

7. A user equipment (UE), comprising:
a transceiver configured to:
receive first information for an uplink (UL) transmission on an UL carrier provided for UL carrier aggregation; and
receive second information associated with a UE maximum output power mode for UL carrier aggregation; and
a processor operably coupled to the transceiver, the processor configured to:
determine, based on the first and the second information, a UE maximum output power for an UL transmission bandwidth on the UL carrier according to a UE power class; and
determine an UL transmit power based on the UE maximum output power,
wherein the transceiver is further configured to transmit, based on the UL transmit power, an UL signal or channel on the UL carrier.

8. The UE of claim 7, wherein:
the UL carrier is a first UL carrier,
a second UL carrier is provided for carrier aggregation, and
the UE maximum output power associated with the first and second UL carriers corresponds to at least one of:
a same determined UE maximum output power for UL transmissions in the first and second UL carriers,
a separately determined UE maximum output power for UL transmissions in the first UL carrier and the second UL carrier, and
a jointly determined UE maximum output power for a first UL transmission in the first UL carrier and a second UL transmission in the second UL carrier in a same time-domain resource.

9. The UE of claim 7, wherein:
the UL carrier is a first UL carrier,
a second UL carrier is provided for carrier aggregation, and
the processor is further configured to determine the UE maximum output power mode according to a band combination or a frequency range combination for the first and second UL carriers.

10. The UE of claim 7, wherein:
the transceiver is further configured to receive an indication corresponding to the UE maximum output power mode for UL carrier aggregation, and
the processor is further configured to determine the UL transmit power based on the indication.

11. The UE of claim 7, wherein:
the UL carrier is a first UL carrier,
a second UL carrier is provided for carrier aggregation, and
the transceiver is further configured to transmit, via uplink control information (UCI), a medium-access-control (MAC) control element (CE), or a radio resource control (RRC) message, (i) values for first and second supported or indicated UE maximum output powers corresponding to the first and second UL carriers, respectively, or (ii) a value for a supported or indicated UE maximum output power mode corresponding to the first and second UL carriers.

12. The UE of claim 7, wherein:
the UL carrier is a first UL carrier,
a second UL carrier is provided for carrier aggregation, and
the processor is further configured to:
determine the UE maximum output power mode for UL carrier aggregation based on the UE maximum output power for the first UL carrier when a simultaneous UL transmission using the first and second UL carriers in a same time-domain resource is not indicated; and
determine the UE maximum output power mode for UL carrier aggregation based on a first UE maximum output power associated with the first UL carrier and a second UE maximum output power associated with the second UL carrier when a simultaneous UL transmission using the first and second UL carriers in a same time-domain resource is indicated.

13. A base station (BS), comprising:
a processor; and
a transceiver operably coupled with the processor, the transceiver configured to:
transmit first information for an uplink (UL) transmission on an UL carrier provided for UL carrier aggregation;
transmit second information associated with a UE maximum output power mode for UL carrier aggregation; and
receive an UL signal or channel on the UL carrier, the UL signal or channel transmitted based on an UL transmit power that is based on an UE maximum output power for an UL transmission bandwidth on the UL carrier according to a UE power class, the UE maximum output power based on the first and the second information.

14. The BS of claim 13, wherein:
the UL carrier is a first UL carrier,
a second UL carrier is provided for carrier aggregation, and
the UE maximum output power associated with the first and second UL carriers corresponds to at least one of:
a same determined UE maximum output power for UL transmissions in the first and second UL carriers,
a separately determined UE maximum output power for UL transmissions in the first UL carrier and the second UL carrier, and
a jointly determined UE maximum output power for a first UL transmission in the first UL carrier and a second UL transmission in the second UL carrier in a same time-domain resource.

15. The BS of claim 13, wherein:
the UL carrier is a first UL carrier,
a second UL carrier is provided for carrier aggregation, and
the UE maximum output power mode is further based on a band combination or a frequency range combination for the first and second UL carriers.

16. The BS of claim 13, wherein:
the transceiver is further configured to transmit an indication corresponding to the UE maximum output power mode for UL carrier aggregation, and
the UL transmit power is based on the indication.

17. The BS of claim 13, wherein:
the UL carrier is a first UL carrier,
a second UL carrier is provided for carrier aggregation, and
the transceiver is further configured to receive, via uplink control information (UCI), a medium-access-control (MAC) control element (CE), or a radio resource control (RRC) message, (i) values for first and second supported or indicated UE maximum output powers corresponding to the first and second UL carriers, respectively, or (ii) a value for a supported or indicated UE maximum output power mode corresponding to the first and second UL carriers.

18. The BS of claim 13, wherein:
the UL carrier is a first UL carrier,
a second UL carrier is provided for carrier aggregation,
the UE maximum output power mode for UL carrier aggregation is based on the UE maximum output power for the first UL carrier when a simultaneous UL transmission using the first and second UL carriers in a same time-domain resource is not indicated; and
the UE maximum output power mode for UL carrier aggregation is based on a first UE maximum output power associated with the first UL carrier and a second UE maximum output power associated with the second UL carrier when a simultaneous UL transmission using the first and second UL carriers in a same time-domain resource is indicated.
